(19) United States
(12) Patent Application Publication
(10) Pub. No.: US 2013/0332961 A1
(43) Pub. Date: Dec. 12, 2013

(54) INFORMATION PROCESSING APPARATUS, INFORMATION PROCESSING METHOD, AND INFORMATION RECORDING MEDIUM

(71) Applicant: Kabushiki Kaisha Toshiba, Tokyo (JP)

(72) Inventor: Satoru ISHIGAKI, Ome-shi (JP)

(73) Assignee: Kabushiki Kaisha Toshiba, Tokyo (JP)

(21) Appl. No.: 13/970,378

(22) Filed: Aug. 19, 2013

Related U.S. Application Data
(63) Continuation of application No. PCT/JP2013/058205, filed on Mar. 7, 2012.

(30) Foreign Application Priority Data
Sep. 7, 2012 (JP) 2012-197890

(51) Int. Cl. H04N 21/482

(52) U.S. Cl. CPC H04N 21/482
USPC 725/44

(57) ABSTRACT

According to one embodiment, an information processing apparatus includes a display control module, a Y-direction control module, and an X-direction control module. The Y-direction control module moves a focus to a button corresponding to at least an adjacent cell in the same column according to a manipulation that moves a focus in the Y direction. The X-direction control module moves a focus to a button corresponding to at least an adjacent cell in the same row or from a button corresponding to at least a cell at one end of a first row to a button corresponding to at least a cell at the other end of a second row adjacent to the first row according to a manipulation that moves a focus in the X direction.

### CROSS-REFERENCE TO RELATED APPLICATIONS

This application is a Continuation Application of PCT Application No. PCT/JP2013/058205, filed Mar. 14, 2013 and based upon and claiming the benefit of priority from Japanese Patent Application No. 2012-197890, filed Sep. 7, 2012, the entire contents of all of which are incorporated herein by reference.

### FIELD

Embodiments described herein relate generally to an information processing apparatus, an information processing method, and an information recording medium.

### BACKGROUND

In recent years, the Internet service business has grown actively. In the Internet service business, information is exchanged in a communication environment between a server on the Internet and a personal computer and/or a mobile terminal (e.g., a cell-phone, a tablet, or a personal digital assistant (PDA)).

A home digital television apparatus (hereinafter, referred to as a TV apparatus) has the advantage that the monitor screen is larger and clearer than that of another apparatus that can display a screen (e.g., a personal computer, a cell-phone, or a tablet). In addition, the home TV apparatus has a further advantage that it can be equipped with a sophisticated audio system. Recent TV apparatuses can connect to the Internet, and more applications for such TV apparatuses are desired. At present, however, there is an opinion that the utilization of such a TV apparatus is insufficient. On the other hand, a small personal computer, a cell-phone, a tablet, or the like has the advantage of portability.

In addition, the TV apparatus can record a large number of programs. With such a tremendous amount of information, various methods of using the TV apparatus to process or organize information can be expected. It is important for the user to put this type of TV apparatus to good use easily. However, as the TV apparatus has more functions, this causes the problem of making the manipulation more complex and therefore more difficult to understand. Furthermore, since menus and their guide images also become diversified, the user may have a hard time trying to acquire desired content or information.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a menu screen displayed on a screen of a display module of a television apparatus according to an embodiment;

FIG. 2 shows another example of the menu screen displayed on the screen of the display module of the television apparatus according to the embodiment;

FIG. 3 shows still another example of the menu screen displayed on the screen of the display module of the television apparatus according to the embodiment;

FIG. 4 shows still another example of the menu screen displayed on the screen of the display module of the television apparatus according to the embodiment;

FIG. 5 shows a state where an information processing apparatus of the embodiment has been incorporated in a digital television receiver;

FIG. 6 is a block diagram selectively showing a characteristic configuration of a cloud application module 231 in FIG. 5;

FIG. 7 shows the relationship between a TV apparatus 300 and a time cloud service server 411 when a scene information function is used in the embodiment;

FIG. 8 shows the relationship between the TV apparatus 300 and the time cloud service server 411 when a scene list function is used in the embodiment;

FIG. 9 shows the relationship between the TV apparatus 300 and the time cloud service server 411 when a scene play function is used in the embodiment;

FIG. 10 shows an example of servers included in the time cloud service server 411 in the embodiment;

FIG. 11 shows an example of components in a metadata server of FIG. 9 in the embodiment;

FIG. 12 shows a configuration of an information processing apparatus and various functional modules of a DTV according to the embodiment;

FIG. 13 selectively shows a block of a menu image processing device in the TV apparatus of the embodiment;

FIG. 14A shows an example of an image displayed on the screen when the TV apparatus of the embodiment is started;

FIG. 14B shows another example of a screen for starting a demonstration in the TV apparatus of the embodiment;

FIG. 14C shows another example of the screen when the demonstration is started in the TV apparatus of the embodiment;

FIG. 14D shows another example of the screen when the demonstration is started in the TV apparatus of the embodiment;

FIG. 14E shows another example of the screen when the demonstration is started in the TV apparatus of the embodiment;

FIG. 14F shows another example of the screen when the demonstration is started in the TV apparatus of the embodiment;

FIG. 14G shows another example of the screen when the demonstration is started in the TV apparatus of the embodiment;

FIG. 15 shows an example of images representing “Home,” “My page,” and “Video” as states of the TV apparatus, with “Home” selected;

FIG. 16A shows a state of the TV apparatus where the “My page” tab has moved to the center and is highlighted;

FIG. 16B shows a state of the TV apparatus where the “My page” tab has moved to the center and is highlighted and, in addition to the guide image of FIG. 16A, other “Guide images” have been additionally displayed;

FIG. 17A shows a state of the TV apparatus where the “Video” tab has moved to the center and is highlighted as a display example of a guide image about “Video”;

FIG. 17B shows not only the guide image of FIG. 17A but also other “Guide images”;

FIG. 18A is a diagram to explain cursor (focus) moving routes in the TV apparatus of the embodiment;

FIG. 18B is a diagram to explain cursor (focus) moving routes in the TV apparatus of the embodiment;

FIG. 18C is a diagram to explain cursor (focus) moving routes in the TV apparatus of the embodiment;

FIG. 18D is a diagram to explain cursor (focus) moving routes in the TV apparatus of the embodiment;

FIG. 18E is a diagram to explain cursor (focus) moving routes in the TV apparatus of the embodiment;

FIG. 19 shows an example of a pop-up image when a message has arrived in the TV apparatus of the embodiment;

FIG. 20 shows an example of a pop-up image when an album has arrived in the TV apparatus of the embodiment;

FIG. 21 shows an image when a message list has been displayed in the TV apparatus of the embodiment;

FIG. 22A shows an example of a pop-up image when a message from a smile messenger has arrived in the TV apparatus of the embodiment;

FIG. 22B shows another example of the pop-up image when an album has arrived in the TV apparatus of the embodiment;

FIG. 22C shows another example of the pop-up image when a message from a forum has arrived in the TV apparatus of the embodiment;

FIG. 23A shows an example of a pop-up image when a recommend message has arrived in the TV apparatus of the embodiment;

FIG. 23B shows an image appearing when a recommend message is opened from the image in FIG. 23A;

FIG. 24 shows a representation of guide images on a mobile terminal (tablet) that can communicate with the TV apparatus of the embodiment;

FIG. 25 is a flowchart to explain an operation when software has been updated in the TV apparatus of the embodiment; and

FIG. 26 is a diagram to explain the relationship between the TV apparatus of the embodiment and the mobile terminal (tablet).

### DETAILED DESCRIPTION

Various embodiments will be described hereinafter with reference to the accompanying drawings.

In general, according to one embodiment, there are provided an information processing apparatus, an information processing method, and a program which are capable of improving the function of informing the user and the usability.

According to an embodiment of the present disclosure, an information processing apparatus includes a display controller and a controller. The display controller is configured to display, on a screen, a plurality of buttons corresponding to one or more cells on a two-dimensional area, the two-dimensional area including (n×m) cells that include an n number of rows in a Y direction and an m number of columns in an X direction perpendicular to the Y direction. The controller is configured to move a focus of a button according to a manipulation and which includes a Y-direction controller and an X-direction controller. The Y-direction controller is configured to move a focus to a button corresponding to at least an adjacent cell in a same column according to a manipulation that moves a focus in the Y direction. And the X-direction controller is configured to move a focus to a button corresponding to at least an adjacent cell in a same row or from a button corresponding to at least a cell at one end of a first row to a button corresponding to at least a cell at an other end of a second row adjacent to the first row according to a manipulation that moves a focus in the X direction.

An embodiment will further be described with reference to the drawings.

An information processing apparatus concerning menu images according to the invention may be configured to be stand-alone or incorporated in a set-top box, a TV apparatus, a recorder, a mobile terminal, or the like. As an example, a case where an information processing apparatus and an information processing method according to the embodiment have been applied to a TV apparatus will be explained.

The information processing apparatus of the embodiment includes a unit that displays not only viewing content but also a service menu related to the content in list form when an instruction to start a cloud service has been given while content is being viewed and a unit that switches and displays related service menus according to a display state.

According to another embodiment, the information processing apparatus includes an overall controller that can connect to a network and a view controller. With the overall controller being out of communication with the network, the view controller can demonstrate a menu image to be obtained when the overall controller has gone into communication with the network.

The overall controller includes a login data management module and a communication data management module. The login management module manages a common login identifier for more than one person and a dedicated login identifier for an individual. The communication data management module distinguishes between communication data corresponding to the common login identifier and communication data corresponding to the dedicated login identifier, thereby selecting a display output.

The communication data management module controls communication data corresponding to the dedicated login identifier privately when the common login identifier is in a login state.

The server may manage login states and logout states of a large number of information processing apparatuses (clients) with a table. In addition, the login management module may transmit a login identifier currently in a login state to the server periodically. This enables the server to grasp the login states of a large number of information processing apparatuses (clients) more accurately.

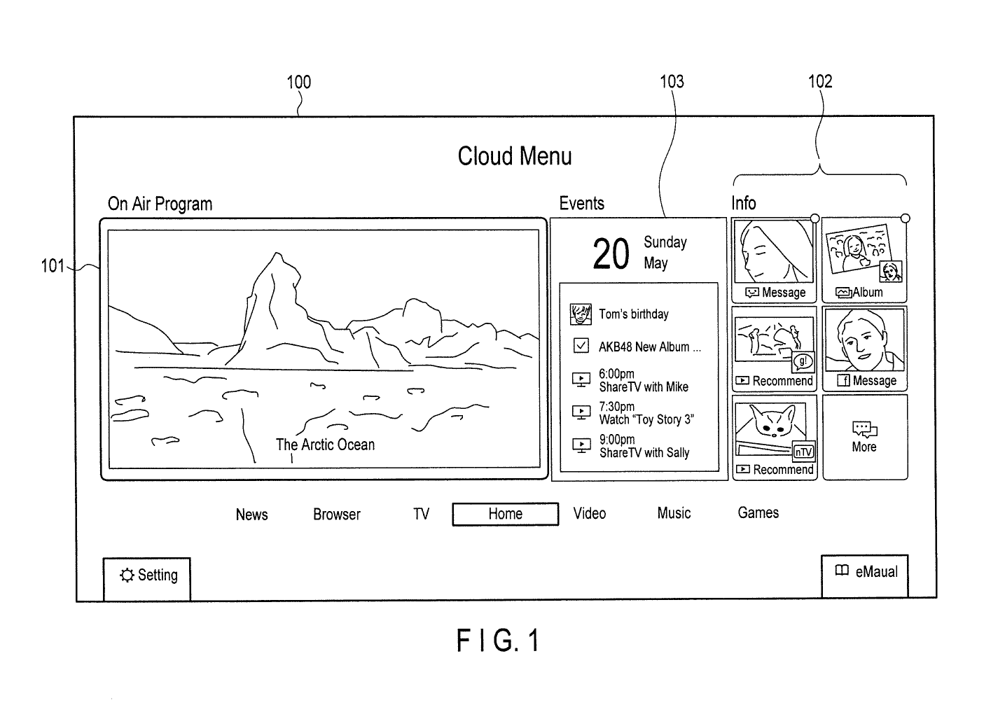

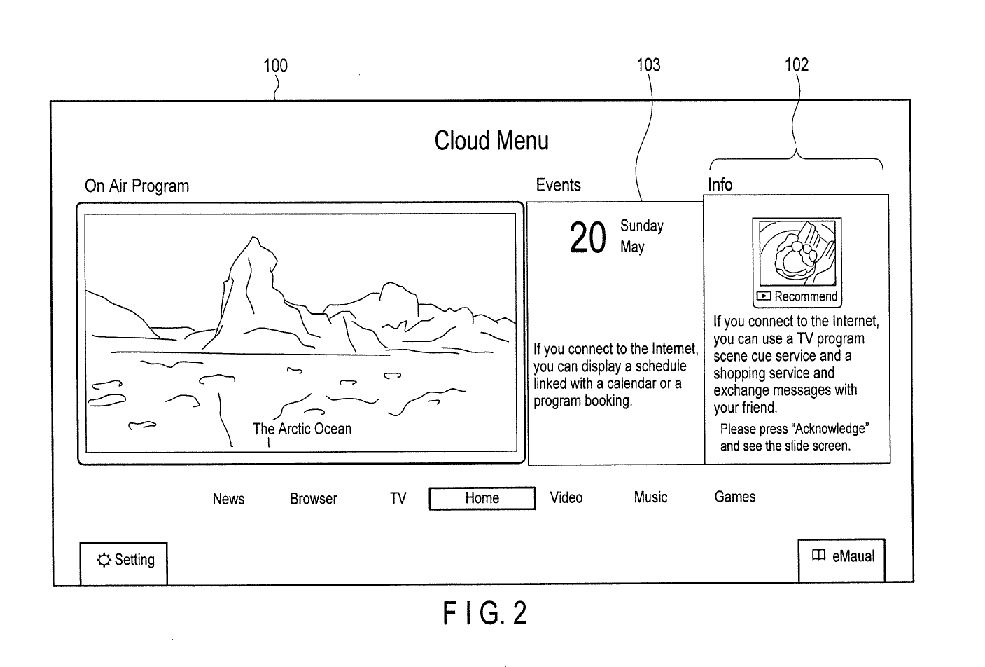

FIGS. 1 and 2 each show an example of a menu image in a demonstration state. This is one example and still other examples will be described later.

In a display area 101 on the left side of a screen 100, an image of a program currently being broadcast or an image of a program being reproduced from a recording device is displayed. In a display area 102 on the right side of the screen 100, a plurality of small-sized guide images are displayed, increasing as follows: one, two, three, . . . . When the number of guide images in the display area 102 has reached, for example, six (see FIG. 1), for example, the message “If you connect to the Internet, you can use a TV program scene cue service and a shopping service and exchange messages with your friend” is displayed in the display area 102 as shown in FIG. 2. In a display area 103 in the center, a calendar is displayed together with a brief summary of information on various events of the day (FIG. 1). Then, each time a certain period of time has passed, the message “If you connect to the Internet, you can display a schedule linked with a calendar or a program booking” is displayed in the central display area 103 as shown in FIG. 2.

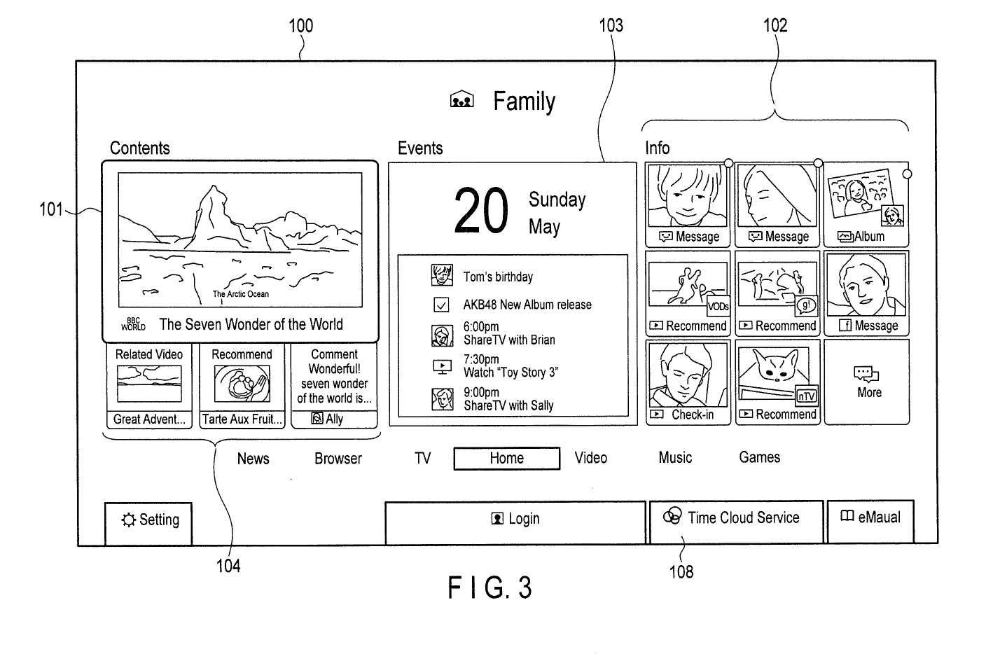

FIG. 3 shows a state where the screen 100 is displayed when the information processing apparatus has been connected to the Internet and login has been started with a family ID. This state is referred to as “home.” In the display area 102, guide images for various transmit-receive boxes to receive notices from your family or friends and recommended data are displayed. The transmit-receive boxes include an outlook, a mail, a message, and a recommended data box. A unique name can be added to a screen frame representing each transmit-receive box. Alternatively, a favorite image can be selected from an image file and added as a guide image. When a message or recommended data has arrived at the transmit-receive box, a corresponding guide image is displayed so as to be marked with, for example, a circle, changed in the frame color, or changed in the frame brightness periodically. When a plurality of recommended data items have arrived at the transmit-receive box, a plurality of circles may be displayed so as to be added to corresponding guide images.

The transmit-receive box (the state of the display area 102 in FIG. 3) can be used for communication between, for example, family members or between family members and their friends. There may be a case where a photo album is received from a friend or a brother living in a distant place. In addition, there may be a case where recommended data is received from a friend. The recommended data includes, for example, recommended program information and recommended shopping information. It further includes recommended scene information and recommended performer information. An example of using the guide image will be explained later.

In addition, a plurality of function-related guide images are displayed in an area 104 under the area 101. The function-related guide images are used when the user operates the information processing apparatus in connection with a reproduced image displayed in the area 101. The details of an example of using the guide image will be explained later. When communication regarding the reproduced image displayed in the area 101 is being performed between the user and an external server (or another user), the guide image can be used.

<Example of Using Guide Images in the Display Area 102>

The user can operate, for example, a remote controller (e.g., a mobile terminal may have a remote controller function) to move a cursor to a desired guide image (e.g., a guide image for a message from a mother to her child). The guide image may be referred to as an operation button. The cursor is displayed as, for example, a frame enclosing a guide image. Alternatively, the brightness of a guide image on which the cursor is focused is higher than that of the rest, that is, the guide image is highlighted. When the cursor is located on a desired guide image, an “Acknowledge” button on the remote controller is pressed (or clicked with a click button), causing a transmit-receive box corresponding to the guide image to be opened, with the result that, for example, a message is displayed. For example, the whole or half of the area 102 can be used for the massage.

In addition, the user can operate the remote controller to open a transmit-receive box for recommended data. The recommended data may be, for example, recommended program information on a recommended program sent from a friend or recommended shopping information. At this time, suppose the user has become interested in the recommended program and wants to watch the program. At this time, when the user moves the cursor to a selection button for the displayed recommended program information and presses the “Acknowledge” button, the TV apparatus can start to reproduce the program automatically. In this case, the reproduced image of the program may be displayed on a small screen. Then, when the user has pressed the “Acknowledge” button, the reproduced image may be displayed on a large screen.

The transmit-receive box can be used to send a message to the receiver's transmit-receive box or mobile terminal. The recommended program information is displayed as, for example, a title name, a scene of a part of the program, a performer's name, or an image of the performer. The recommended program information further includes a broadcast channel number, broadcast time and date, such information as performer's prologue, and a content server address.

A method of causing the TV apparatus at this time to acquire program content includes a first method of driving a recording device connected to the TV apparatus to acquire program content and a second method of acquiring program content by downloading the content from a content server via the Internet. In the first method, a program list search function for a program recorded in the recording device operates. In the second method, the address of a server with content included in the preceding recommended program information is used.

The recommended program information may include data processed for the user to acquire the program content easily. That is, the program information recommended by the friend is uploaded from the friend's device to the server. On the server, the recommended program information is processed into program information the user can use. The reason why the recommended program information is processed is that a broadcast program may differ in broadcast channel number, broadcast time slot, or the like from region to region. Therefore, program information is processed (e.g., the broadcast channel number, broadcast time slot, and the like are processed) on the server so that the user can easily search for the same program as that recommended by the friend and obtain the program and then offer the program to the user. The method of acquiring recommended program information further includes a method of acquiring the information from calendar information.

In addition, using a guide image in the display area 102, a mail, a short message, or the like can be transmitted to a family member or to a friend entered in a management module that manages the guide image. The friend in this case is a friend common to the family members. Information on another family or a friend common to the family members is recognized by a home management module that stores and manages home guide images and is entered in the management module.

<Example of Using Guide Images in the Display Area 104>

For example, suppose a drama (displayed in the area 101) in a program the user is now watching has a scene the user likes or a scene where the user's favorite performer appears. In such a case, the user operates the remote controller, selects a recommended guide image, and presses the “Acknowledge” button. Then, program information on the program the user is now watching is uploaded to a server as attention (or notice) program information. The server can use the attention program information as a material for creating recommended program information and/or information for creating a tag list for the program. Since attention program information on various programs is sent from many viewers to the server, the server can perform statistical processing on the basis of the attention program information and create a program information list of programs ranked in descending order of popularity.

In addition, the user can operate the remote controller to select a comment guide image and press the “Acknowledge” button. Then, a screen that prompts the user to input a short message about a program (a program image displayed in the area 101) the user is watching appears, enabling the user to input a message. The user can input a message from, for example, the remote controller or the keyboard display of the mobile terminal.

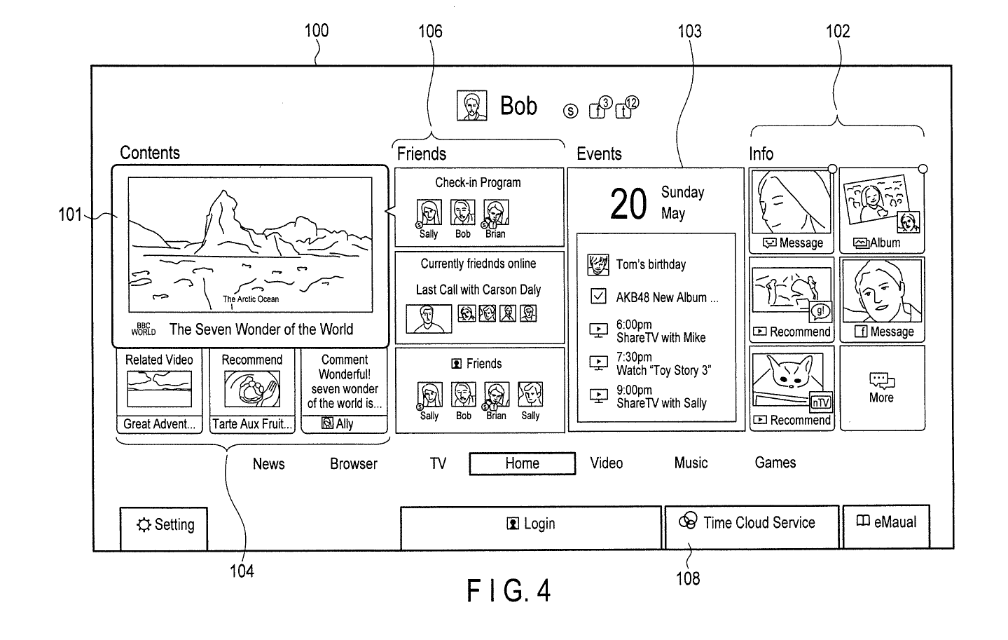

FIG. 4 shows a display state of the screen 100 when the information processing apparatus has been connected to the Internet and logged in with a personal ID. In the screen 100, a display area 106 for guide images to perform communication with a friend is obtained between the area 101 and the area 103.

In the display area 106, there are, for example, three types of guide images. In an upper guide image (Check-in Program), a list of others (friends) simultaneously watching a program the user is now watching is displayed. In a middle guide image (Currently friends online), although the information processing apparatus has been connected to a network, a list of others (friends) watching a program differing from the program the user is now watching is displayed. In a lower guide image (Friends), a list of others (friends) with the information processing apparatus not connected to the network is displayed. The login state of the information processing apparatus is transmitted to the server periodically. Therefore, the server can distinguish between a user not connected to the network, a user connected to the network, and a user who is connected to the network and is watching the same program. The server is monitoring the statuses of a plurality of users. Accordingly, the information processing apparatus can present three types of guide images as shown in the display area 106.

<Example of Using Guide Images in the Display Area 106>

For example, when son B of friend A appears in a drama of a program the user is now watching, the user may want to inform friend A or friend A's family of this. In addition, when friend A is searching for stray dog C and the user has heard the news about stray dog C, the user may want to inform friend A or friend A's family of this. In those cases, the user can use guide images displayed in the area 106.

The user can operate the remote controller to select, with a cursor, a guide image in which a desired friend is displayed and press the “Acknowledge” button. Then, there appears a screen that enables the user to send a message to the selected friend.

For the communication, the user can use guide images in which a recommendation and a message displayed in the display area 102 have been written. The user can operate the remote controller to select, with the cursor, a guide image in which a desired image has been displayed and press the “Acknowledge” button. Then, a message for a family member or a person entered in the transmit-receive box in the selected image can be transmitted. Guide images in the display area 106 can be used primarily for private communication.

<Example of Using a Guide Image in the Display Area 103>

In this guide image, not only is a calendar displayed, but also the titles of events and a schedule of the day are displayed briefly. If the user wants to know detailed information on the events or schedule, the user selects the title of an event or a schedule with the cursor and clicks the title, thereby further displaying detailed information. The detailed information can be browsed with, for example, a URL address.

In the calendar, the user's schedule can be written. When the display area for the calendar has been selected with the cursor, calendar use items are displayed. When a schedule write item has been selected, a schedule can be input from the remote controller or mobile terminal.

<Movement of Operation Screen>

The guide images shown in FIGS. 2, 3, and 4 excluding a viewing image in the area 101 can be displayed on a mobile terminal which is a touch input operation module with a display module. That is, the information processing apparatus can move the guide image and a manipulate signal corresponding to the guide image to a mobile terminal via a communication function of the TV apparatus. This enables the mobile terminal to maintain communication with the TV apparatus and manipulate the information processing apparatus making use of guide images as described above.

<Cloud Service Button>

On the screen 100, a button 108 (whose name and display position are not restricted to this embodiment) called, for example, “Time Cloud Service” is displayed.

Now, suppose, while watching content displayed in the area 101, the user selects the cloud service button 108 with the cursor and clicks the button 108 to give a cloud service instruction. Then, a cloud service application in the apparatus can be started. When the cloud service has been started, not only viewing content but also a service menu related to the content is offered from a time cloud server, enabling the service menu to be displayed in list form. It is possible to switch between related service menus according to a display state. Cloud services are available in various forms and will expand in various fields. As for cloud services, some typical examples will be explained later. The guide images shown in FIGS. 2, 3, and 4 may be activated when the button 108 is turned on and the apparatus is connected to the time cloud service server. When the cloud service application is activated, a specialized key provided on the remote controller may be operated.

The apparatus may be connected to the cloud service server when a specific button on the remote controller or mobile terminal has been operated.

<A Block Configuration of the Information Processing Apparatus>

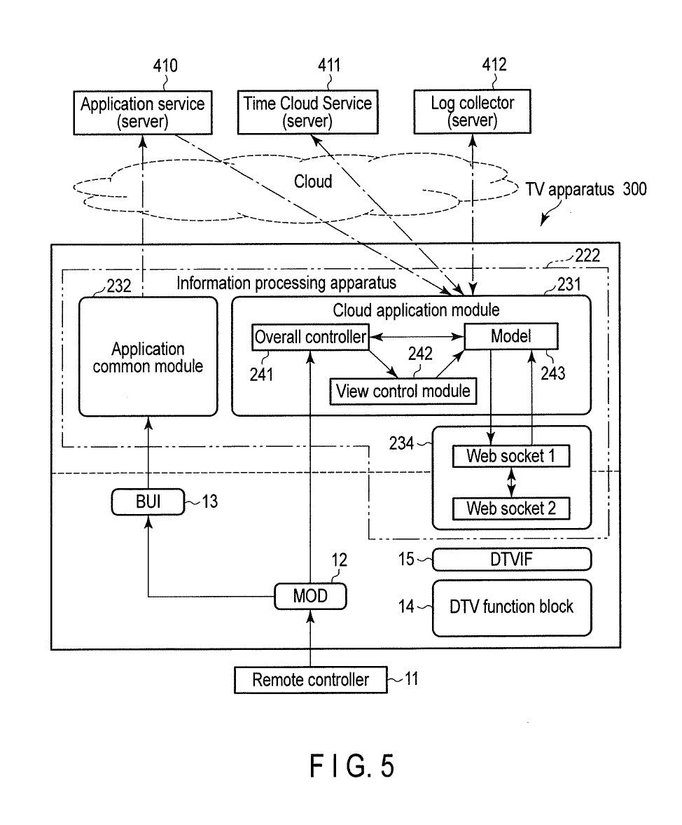

FIG. 5 shows an overall configuration of the TV apparatus 300 to which the information processing apparatus and the information processing method according to the embodiment have been applied. In FIG. 5, the basic functions (including television signal reception, demodulation, control signal processing, 3-D-related signal processing, recording, audio processing, video processing, and a display function) of a digital television receiver (hereinafter, abbreviated as a DTV) are collectively called a DTV function block (or module) 14. The DTV function block 14 is connected to an information processing apparatus 222 via a DTV interface 15. The information processing apparatus 222 may be referred to as a browser section.

In the embodiment, the information processing apparatus 222 includes a cloud application module 231, an application common module 232, and a socket module 234. This classification is not restrictive. The cloud application module 231 may be defined as the information processing apparatus 222.

The socket module 234 includes a server web socket viewed from the DTV interface 15 and a client web server viewed from the browser.

The cloud application module 231 includes an overall controller 241, a view control module (it may be referred to as a controller) 242, and a model 243. The overall controller 241 performs various event processes in response to a command or an instruction. The overall controller 241 controls the view control module 242, thereby realizing various drawing processes. The view control module 242 can obtain various images and control signals in the aforementioned screen 100. The images and control signals based on the operation of the view control module 242 pass through, for example, the model 243 and socket 234 and are displayed as images and control buttons on the display module of the TV apparatus.

The model 243 can access a server, acquire information from a server, transmit information to a server, operate a DTV, and receive data from a DTV. Therefore, the model 243 can receive a message from the DTV and transmit the message to the server. In addition, the model 243 together with the view control module 242 can display the message received from the server on the screen of the display module of the DTV. As for servers, there are an application service server 410, a time cloud service server 411, and a log collector server 412. There are still other servers (not shown).

The user can manipulate the remote controller 11 to control the DTV and information processing apparatus 222. A manipulate signal from the remote controller 11 is distributed at a moderator 12. A key event distributed for use with the cloud application module 231 is input to the overall controller 241. A key event distributed for use with the application common module 323 is input to the application common module 232 via a browser interface 13. The application common module 232 can request a specified application from an application server 410 according to an application request command. The application sent from the application server 410 is taken in by the cloud application module 231 via the model 243. The log collector server 412 can collect logs used in the information processing apparatus 222 and other connection devices.

The time cloud service server 411 can be connected to other various servers and other information processing apparatuses via the network. The time cloud service server 411 can send various service data items to the information processing apparatus. The time cloud service server 411 can relate video content to scene information or a tag list created by a metadata maker or a user. The related data items are arranged on, for example, a table.

Each block and its operation (including the aforementioned operations and operations described below) shown in FIG. 5 may, of course, be realized by a set of instructions constituting software (also referred to as a program). Of course, a processor or a central processing unit (CPU) for realizing data processing with software may be incorporated in each block of FIG. 5. The software, which is stored in a memory (storage medium), can be upgraded. The data (software) in the memory can be read by a computer.

The DTV, which includes a plurality of digital tuners, can receive a plurality of channels at the same time. When signals on a plurality of channels have been demodulated, a plurality of streams are obtained. Each stream includes packets of a television program, a control signal, and the like. The streams of a plurality of programs on a plurality of channels are recorded into, for example, a hard disk drive (HDD) connected via a USB connection cable. The HDD can also record management information for managing program information on recorded programs.

<Recording Booking, Viewing Booking, Recording History, and Viewing History in DTV>

In the TV apparatus 300 to which the information processing apparatus and information processing method according to the embodiment have been applied, a recording booking function, a viewing booking function, a recording history function, and a viewing history function have been constructed.

The recording booking means that the user plans to record a desired program into a desired recording device (e.g., an HDD). The recording booking function creates a program listing from, for example, electronic program guide (EPG) data and displays the listing. The user operates the remote controller to select a desired program with the cursor, thereby booking recording. This causes the desired program to be recorded in, for example, an HDD. When a plurality of recording devices are connected to a home network, the user can specify an HDD in which programs are to be recorded.

The recording history is information on the recording booking or programs recorded by automatic recording. Recording time and date and recorded program information (data on broadcasting station name, broadcast time slot, and the like) are included in the recording history information.

The viewing booking means that the user plans to reproduce a desired one among a large number of programs already recorded in the HDD. Booking information includes an HDD that has stored the program, a broadcasting station name of the relevant program, a program name of the program, and a reproduce start time of the program.

The viewing history includes program information (data on a recording device, a broadcasting station name, a broadcast time slot, and the like) on a program reproduced on the TV apparatus 300.

Each of the recording booking, viewing booking, recording history, and viewing history can be managed by each family member. In addition, each of them can be managed as open information shared by all the members of the family. This is because data including recording booking, recording history, viewing booking, and viewing history is managed by family and individual login identifiers at the management module.

<Relationship Between the Time Cloud Service Server and the Information Processing Apparatus>

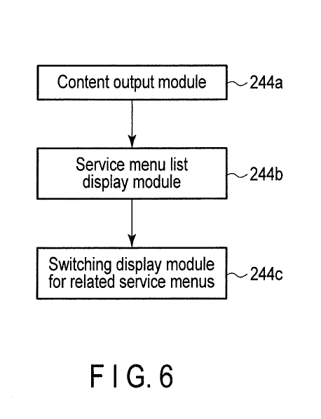

FIG. 6 shows a configuration of a module (in either software or hardware) composed of the overall controller 241, view control module 242, and model 243 in FIG. 5. A content output module 244a outputs viewing content to the display module. When an instruction to request a service from a specific server has been input while content is being output to the display module, a service menu list display module 244b can cause the display module to display a service menu related to the content in list form. A switching display module 244c can switch to and display a further related service menu according to the display state of the service menu in response to the input of a subsequent instruction. Hereinafter, various service functions related to this function will be explained.

<Scene Information Function (Also Referred to as Scenefo)>

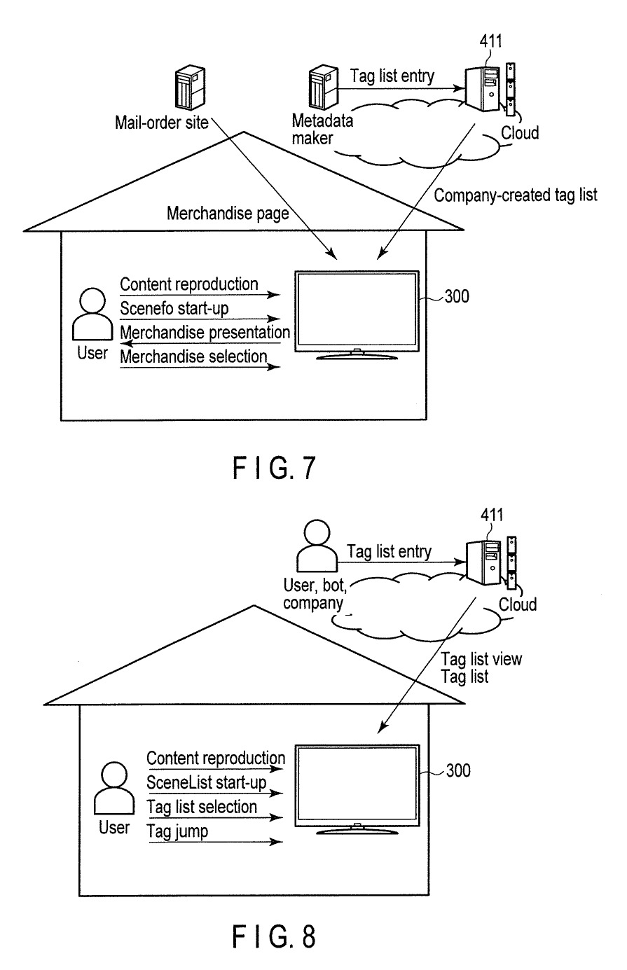

FIG. 7 schematically shows the relationship between the TV apparatus 300 and the time cloud service server 411 when a scene information function (Scenefo) is used. In the embodiment, a service where video content is connected to scene information is used as scene information, which is abbreviated as, for example, “Scenefo.”

While the user is watching a program, if the user has found a curious scene, the user presses, for example, “Scene information key” on the remote controller (preferably in a state where the time cloud service button 108 of FIG. 4 is on). Alternatively, when a curiosity button (a curiosity key) is displayed in the area 104, the user presses the key. Then, the scene information service application starts. At the same time, the browser is also activated. Next, the user can browse a tag list or a scene list obtained by collecting scenes related to curious scenes as a plurality of tags. More than one tag list or more than one scene list may be used. In a normal tag list, a plurality of tags have been created in the same program. In a scene list, scenes in the same program and scenes in another program may have been created in a unified manner. The tag list and scene list are also included in scene information. The scene information further includes various pieces of information as explained later.

Some tag lists or scene lists may be created by metadata makers or general users and uploaded to the time cloud service server 411.

Here, a tag list or a scene list is interval information whereby a scene in which the same performer appears can be segmented in units of several seconds or several tens of seconds in, for example, a certain program. As the interval information, a reproduction elapsed time (referred to as a relative time) since the starting position of a program is used. A pair of the starting time of a scene and the ending time of the scene determines one scene unit.

The time cloud service server 411 refers to scene information (a program name, a channel number, a time location (also referred to as a relative time since the starting position) on a program of a curious scene) created on the basis of the manipulation of “Scene information key,” thereby determining a corresponding tag or scene. The tag is one unit of tags constituting a tag list. The tag list is normally created in the same program. The scene is one unit of scenes constituting a scene list. The scene list can be created, extending not only into a list of a program the user is now watching but also over a plurality of programs. A scene list created over a plurality of programs can be created from a plurality of programs, for example, in the same or a similar genre.

The scene list is attached with, for example, such a name or a comment as represents a program. A plurality of different scenes may have been created for one scene in a program. The reason for this is that a scene the user is curious about may be a scenic backdrop, a car appearing in the scene, or an actor driving the car in the scene. Therefore, a scene list about landscapes, a scene list about cars, a scene list about actors, and the like may be created.

As described above, when the user operates the “Scene information key” in a certain scene of a program, scene information on the corresponding scene is sent from the time cloud service server 411 to the information processing apparatus. That is, the apparatus includes a module that displays not only viewing content but also a service menu related to the content in list form when an instruction to start a cloud service has been given while the user is watching content.

A plurality of scenes regarding the scene information are displayed, for example, on the right side of the screen 100. The user can refer to a comment or a name displayed together with the scene, select a desired scene by manipulating the remote controller, and press the “Acknowledge” button. Then, on the screen 100, various scenes concerning the selected scene are displayed in the form of category selection buttons, including “Merchandise information,” “Outlet information,” “Regional information,” “Personality information,” and “Tag reproduction.”

The display state of the screen 100 at this time means that more detailed information about the merchandise, outlets, regions, personalities, “Tag reproduction,” and the like that appeared in the curious scene can be provided for the user. When “Tag reproduction” has been selected, this means that a tag can be reproduced. That is, the apparatus includes a module that switches and displays related service menus according to the display state.

When the user has selected, for example, the “Merchandise information” button, the screen 100 goes into a merchandise selling site browsing state. This is because scene information sent from the time cloud service server 411 includes not only scene list or tag list data but also a homepage address of the selling site or the like as extended link information.

When the user has selected the “Outlet information” button, the screen 100 can go to a guide site for outlets that appeared in the curious scene. When the user has selected the “Regional information” button, the screen 100 can go to a guide site for a tourist board, an administrative institution, or the like in the region. At this time, information sent from the time cloud service server 411 may include map information created on the basis of GPS information. This enables the user to check whether an outlet or the like is near the user's home, looking at a map.

In addition, if the user has selected the “Personality information” button, the screen 100 can move to a guide site for a profile of the actor, another program in which the actor appears, a tour of the theater, support group information, and the like. Moreover, another key may be caused to function as the “Scene information key.”

<Scene List Function (Also Referred to as SceneList>

FIG. 8 schematically shows the relationship between the TV apparatus 300 and the time cloud service server 411 when a scene list function (SceneList) is used. The scene list function includes a module similar to that of the scene information function (Scenefo).

For example, in a soccer broadcast program, the user may want to see a scene of shooting at goal or a scene of a specific player appearing in the field. Alternatively, in a sumo broadcast program, the user may want to see a scene of a specific wrestler (a sumo wrestler) appearing in the ring.

In such a case, when the user currently watching a program particularly has wanted to view a specific scene, the user presses, for example, the “Scene list key” on the remote controller (preferably in a state where the time cloud service button 108 of FIG. 4 is on). Then, the scene list function starts, enabling the user to look at a scene list or a tag list of scenes equivalent to or similar to the scene the user wants to view.

The tag list is normally created in the same program. The scene list may include not only a list including the program the user is now watching but also a scene list covering a plurality of programs. For example, in a sumo broadcast program, a sumo match in which a specific wrestler appears is played once a day and sumo broadcast programs for a plurality of days have been recorded. Therefore, there is a scene list of a plurality of programs. The scene list is attached with, for example, such a name or a comment as represents the program. A plurality of scene lists or tag lists may have been created for one scene of a program. The scene list or tag list is also provided by the time cloud service server 411. That is, the apparatus includes a module that displays not only viewing content but also a service menu related to the content in list form when an instruction to start a cloud service has been given while the user is watching content.

When the user has selected a desired scene list name and pressed a play button, a scene according to the selected scene list or tag list is reproduced. The user can select a desired scene list name and press, for example, the “Acknowledge” button. After the user has pressed the “Acknowledge” button, scene cells constituting the scene list are displayed in array form. The array is in the order of time passage. Here, when the user has moved the cursor to the position of a desired scene cell and pressed the play button, reproduction is started with the scene specified by the cursor in the order in which the scenes have been arranged. That is, the apparatus includes a module that switches and displays related service menus according to the display state.

<Scene Play Function (Also Referred to as ScenePlay)>

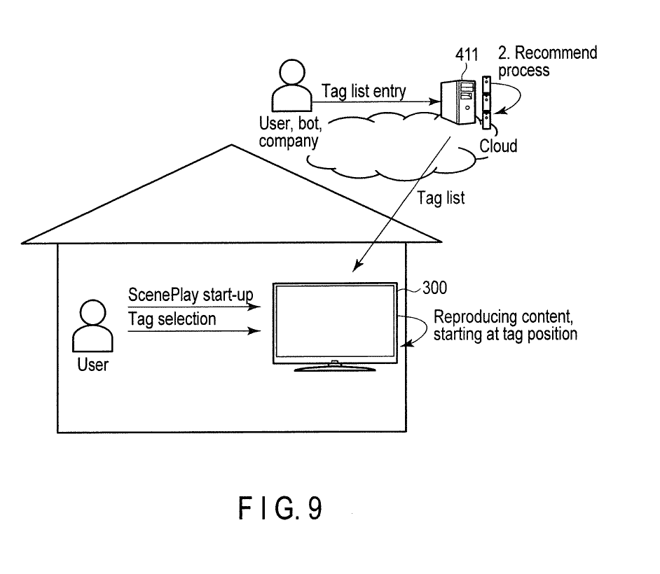

FIG. 9 schematically shows the relationship between the TV apparatus 300 and the time cloud service server 411 when a scene play function (ScenePlay) is used. The scene play function includes a module similar to that of the scene information function (Scenefo).

As for a long program or a program watched partway through, the user may want to reproduce the program, starting with a part of the program. In addition, the user may want to reproduce the program, starting with a favorite scene. In such a case, the user clicks the “Scene play” button (guide image) displayed in, for example, the area 104 of the screen 100 (preferably in a state where the time cloud service button 108 of FIG. 4 is on). Then, the image arrangement is changed and a plurality of small images of representative recommended scenes are displayed for the program the user is currently watching. For example, like the guide images shown on the right side of FIG. 3, a plurality of small images of representative recommended scenes are displayed. That is, the apparatus includes a module that displays not only viewing content but also a service menu related to the content in list form when an instruction to start a cloud service has been given while the user is watching content.

On the screen 100 in FIGS. 1 to 3, a guide image for “Scene play” is not displayed. However, various guide images can be displayed by moving the cursor to any one of the guide images in the area 104 and operating the scroll key on the remote controller. Since a guide image for “Scene play” is among the guide images, the user clicks the guide image. Then, a plurality of small images of representative recommended scenes are displayed in connection with the program the user is currently watching.

The user can start to reproduce the program, beginning with a scene of the small image by operating the remote controller to select the desired small image with the cursor and pressing the play button. That is, the apparatus includes a module that switches and displays related service menus according to the display state.

A recommended scene is created and prepared at, for example, the time cloud service server 411. Various methods of creating a recommended scene can be considered. The time cloud service server 411 collects, for example, curious scene information and/or recommended data from many clients (users). Then, statistics on program information on curious scene information and/or program information included in recommended data are taken. By the statistical processing, a plurality of scenes specified a number of times in program information are ranked on a program basis. A plurality of scenes high in the rank in a program are set as representative scenes and representative scene information corresponding to the representative scenes is created. By doing this, in each program, a plurality of representative scenes are determined. The representative scene information includes the name of a program, the broadcast date and time of the program, and a relative time until the reproduction of a representative scene is started when the program is reproduced from the beginning.

In addition, the time cloud service server 421 is configured to be capable of receiving a program recording destination (e.g., a hard disk drive, a DVD, or a BD) information and recorded program information from the user's information processing apparatus and grasping which program has been recorded in which recording medium. Therefore, when a representative scene is created, the TV apparatus can read content including the representative scene from the recording medium at high speed and present a plurality of representative scenes.

<Selection, Switch, or Transition of the Scene Information Function (Scenefo), Scene List Function (SceneList), and Scene Play Function (ScenePlay)>

The user may want to move to the scene list function (SceneList) or scene play function (ScenePlay) after having entered (a) the scene information function (Scenefo). In addition, the user may want to move to the scene play function (ScenePlay) or scene information function (Scenefo) after having entered (b) the scene list function (SceneList). Moreover, the user may want to move to the scene list function (SceneList) or scene information function (Scenefo) after having entered (c) the scene play function (ScenePlay).

The information processing apparatus has a function switching function for such a case. Various methods of switching functions can be considered. For example, after a scene list or a tag list has appeared, the scene information key, scene list key, and scene play key may be displayed, prompting the user to select any one of them. Alternatively, the scene information key, scene list key, and scene play key may be provided on the remote controller or displayed on the display module of a mobile terminal.

Furthermore, a scene-related function switching key may be prepared. The switching key may be configured to be operated repeatedly to switch the functions cyclically in this order even if any function is in operation: the scene information function (Scenefo), scene list function (SceneList), and scene play function (ScenePlay).

<Control Information Used when the Scene Information Function (Scenefo), Scene List Function (SceneList), or Scene Play Function (ScenePlay) is in Operation>

The time cloud service server 411 can further transmit control information for controlling a TV function to the information processing apparatus. The time cloud service server 411, which has an information extended linkage function, can correlate data items transmitted from a metadata database server and many users with one another to create extended linkage data. The time cloud service server 411 has a correlating table for correlating data items with one another. Various methods of correlating data items with one another can be considered. For example, there is a method of correlating various data items with one another using a common identifier. In addition, sub-identifiers may be added to the identifiers, thereby classifying the degrees of correlating data items or the types of data items correlated with one another on the basis of the sub-identifiers.

As described above, scene information that correlates program information with outlets, merchandise, or the like can be created.

The expanded linkage data may include a control signal that controls the TV function automatically. For example, when the DTV function block 14 of the TV apparatus includes a 3D signal processing module, a control signal for bringing a content process into a 3D processing mode can be transmitted. The DTV function block 14 of the TV apparatus can respond to the control signal. The 3D process includes the process of converting a 2D signal into a 3D signal. The 3D process further includes the process of supplying a 3D signal to a 3D display. The 3D display is available as a display that enables the user to see a 3D image with the naked eye or as a display that enables the user to see a 3D image by use of glasses. Therefore, when having determined that a scene or an image the user is going to see should be viewed in three dimensions and that the TV apparatus has a 3D function, the time cloud service server 411 can transmit a control signal that brings the TV apparatus into a 3D processing state automatically.

In addition, the time cloud service server 411 sends an audio control signal and/or an audio signal corresponding to a scene. The DTV function block 14 of the TV apparatus can respond to the audio control signal and/or audio signal. In particular, when the scene information function and scene list function are in operation, the TV apparatus is in a reproduction situation differing from a situation where a normal program is reproduced continuously. Therefore, the audio system of the TV apparatus outputs music (e.g., BGM) or sound suitable for a scene.

Furthermore, it may be better to adjust the brightness or the color of an image according to a scene the user is watching. Even in such a case, the time cloud service server 411 can include image adjustment data in extended linkage data and transmit the resulting data according to the user or scene. For example, suppose a scene list has been requested in a situation where, for example, the information processing apparatus has been logged in to with a home login ID. Then, it is assumed that a specific scene (e.g., a scene of violence) is in a plurality of scenes specified by the scene list. In such a case, the time cloud service server 411 may include a control signal that causes the reproduction of the specific scene to be skipped in the extended linkage data and transmit the resulting data to a client.

The time cloud service server 411 can receive from the information processing apparatus not only the login identifier but also specification information including manufacturer information on, for example, the TV apparatus or mobile terminal and display capability and store them. The reason for this is that the display capability, control method, and the like of the TV apparatus may differ from maker to maker. When transmitting a control signal to the information processing apparatus (client) while the scene information function (Scenefo), scene list function (SceneList), or scene play function (ScenePlay) is operating, the time cloud service server 411 can transmit a control signal suitable for the client. In addition, when display data, such as a message created by the time cloud service server 411, is transmitted, the time cloud service server 411 may transmit different languages, including Japanese, English, French, Korean, Chinese, German, and Spanish, and/or sounds according to the setting of the information processing apparatus (client).

Furthermore, the time cloud service server 411 is configured to transmit a power-saving instruction or a power-saving assistance request signal when a TV apparatus including an information processing apparatus (client) has a power-saving function. The time cloud service server 411 can receive a power demand situation and power forecast information from, for example, a power plant company. When the power supply quantity is getting tight with respect to the power consumption, the time cloud service server 411 can inform each information processing apparatus of power-saving assistance to achieve power saving.

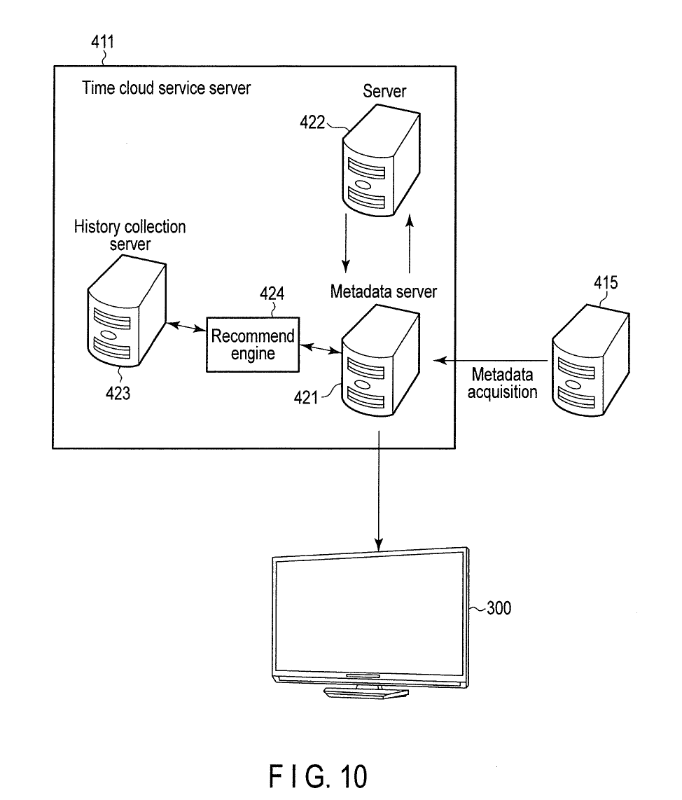

FIG. 10 shows an example of the organization of servers constituting the time cloud service server 411.

Numeral 421 indicates a metadata server. The metadata server 421 can receive various metadata items from a data creation server 514 in an outside data creation company. Metadata, which is program information, includes many pieces of information on programs, including broadcast channels, broadcast times, and performers. Metadata is used to create scene information, a tag list, a scene list, and the like at the metadata server 421. There is control information attached to a tag list, a scene list, and scene information.

In addition, the metadata server 421 can enter a tag list and/or a scene list into a tag list creation server 422. Moreover, the metadata server 421 can acquire a tag list and/or a scene list from the tag list creation server 422 at the request of a client (information processing apparatus) and provide it for the client (information processing apparatus). The metadata server 421 can create scene information using metadata and transmit it to the client (information processing apparatus).

The metadata server 421 collects, for example, curious scene information and recommended data from many clients (users) and transfers the collected data to a history collection server 423. The history collection server 423 takes statistics on program information on curious scene information and/or program information included in recommended data. By the statistical processing, a plurality of scenes specified a number of times in program information are ranked on a program basis. A plurality of scenes high in the rank in a program are set as representative scenes and representative scene information corresponding to the representative scenes is created. By doing this, in each program, a plurality of representative scenes are determined. The representative scene information includes the name of a program, the broadcast date and time of the program, and a relative time until the reproduction of a representative scene is started when a program is reproduced from the beginning.

When a client has requested a scene play, the metadata server 421 can cause the server 423 to send back representative scene information on the requested program to the client.

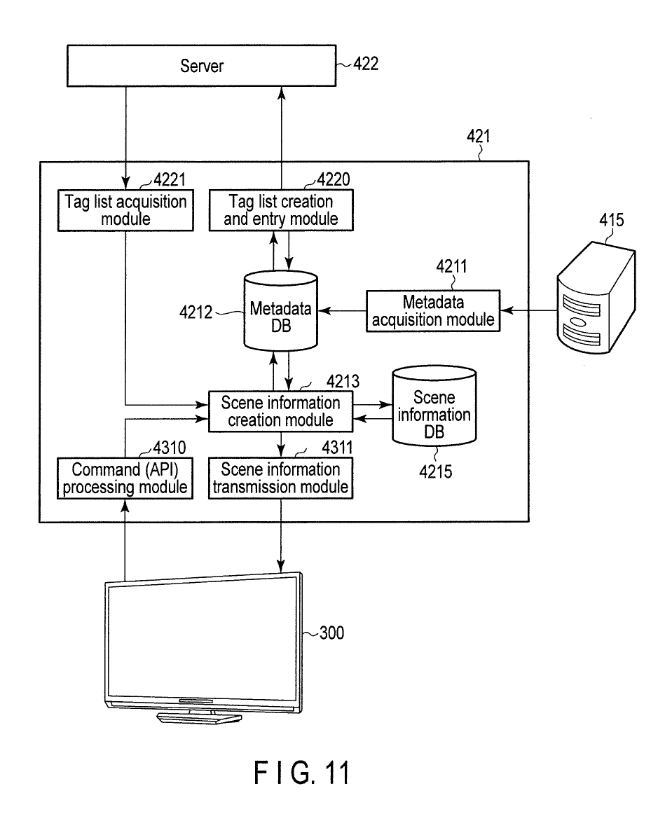

FIG. 11 shows an internal configuration of the metadata server 421. A metadata acquisition module 4211 receives various metadata items from the data creation server 514 and stores the metadata items in a database unit 4212. A tag list creation and entry module 4220 creates a tag list using metadata and enters the created tag list into the server 422. A tag list acquisition module 4221 can acquire a tag list from the tag list creation server 422 by request from a client (information processing apparatus) and provide the tag list for the client (information processing apparatus). A scene information creation module 4213 creates scene information using metadata and stores the crated scene information in a scene information database unit 4215. At the request of a client, an information transmission module 4311 transmits scene information and/or a tag list and/or a scene list to the client.

A command processing module 4310 receives an instruction and/or information from the client and reflects it in the operation of the metadata server 421.

The aforementioned blocks show only representative ones. The database unit 4212 stores various data items in addition to the above-described items. In addition, various control blocks are used to achieve operations described later.

The metadata server 421 performs information extended linkage processing. For example, when a client (user or information processing apparatus) has transmitted scene information on a curious scene to the metadata server 421 as described above, the metadata server 421 can transmit not only data corresponding to the request of the client but also the extended linkage data explained above. Therefore, the user obtains the convenience of being able to use the extended linkage data effectively.

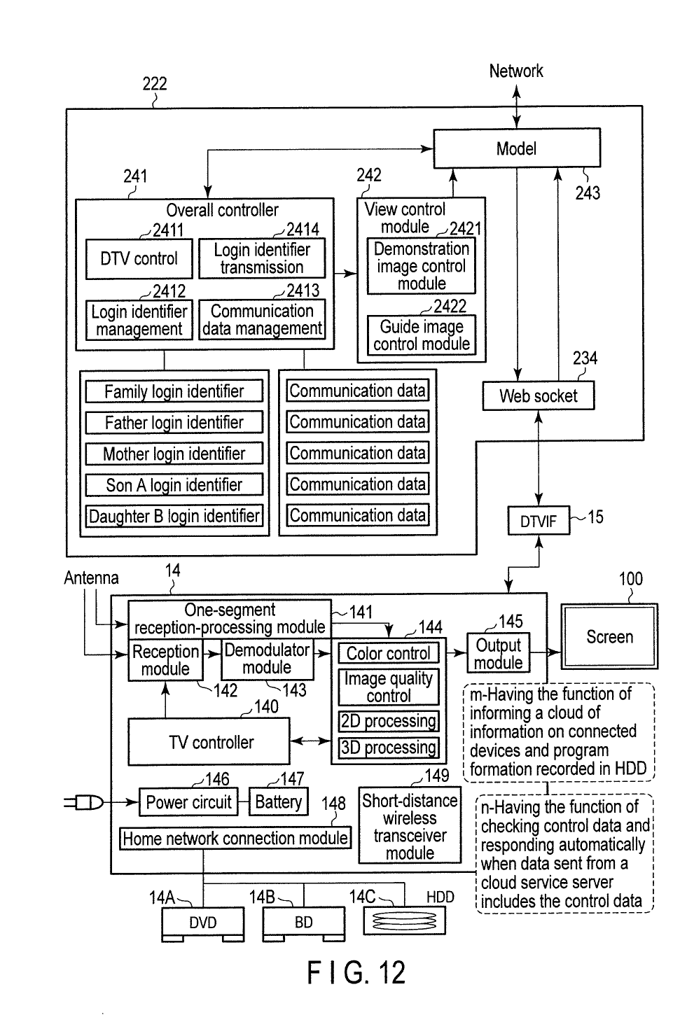

FIG. 12 shows a configuration of the information processing apparatus 222 and DTV function block 14 together with the relationship between them. The overall controller 241 includes a DTV control module 2411, a login identifier management module 2412, a communication data management module 2413, and a login identifier transmission module 2414. In this description, the control module may be referred to as a controller. The DTV control module 2411 may control the DTV function block 14 on the basis of a user operation or control various TV function blocks 14 on the basis of control data from the time cloud service server 411. When a login identifier explained in FIGS. 3 and 4 has been input, the login identifier management module 2412 controls the storage of the login identifier and manages family and individual identifiers as table data. The communication data management module 2413 manages communication data so that the communication data items may correspond to the individual login identifiers. For example, when the user logged in has accessed an external server, the communication data management module 2413 manages its history data. The history data includes an access destination address, transaction data, and the like. The communication data management module 2413 can also classify and store data items sent from the cloud service server 411 and use the data as display data. In addition, data including recording booking, recording history, viewing booking, and viewing history is managed by family and individual login identifiers.

The login identifier transmission module 2414 transmits the logged-in login identifier to the cloud service server 411. The cloud service server 411 manages login identifiers from many users and uses them when providing guide images as explained in FIG. 4.

The view control module 242 includes a demonstration image control module 2421 and a guide image control 2422. This enables a demonstration image and a guide image as explained in FIGS. 1 to 4 to be provided for the DTV side.

The DTV function block 14 includes a one-segment reception-processing module 141 that receives a signal from an antenna, a reception module 142 that receives satellite broadcasting and terrestrial digital broadcasting, and a demodulator module 143. The reception module 142 and demodulator module 143, which include a plurality of tuners, can receive broadcast programs on a plurality of channels simultaneously and demodulate them. A plurality of demodulated program signals can be converted into a DVD format at a DVD device 14A and recorded onto a digital versatile disc. Alternatively, the demodulated program signals can be converted into a BD format at a BD device 14B and recorded onto a Blu-ray disc. Moreover, in any stream, the demodulated program signals can be recorded onto a hard disk with a hard disk drive 14C. The DVD device 14A, BD device 14B, and hard disk drive 14C are connected to the DTV function block 14 via a home network connection module 148. The hard disk drive 14C may be of a type to be connected via a USB cable. The hard disk drive 14C may be based on a method capable of recording all the programs on a plurality of channels (e.g., a set of six channels) simultaneously for, for example, about one to three weeks. This type of function may be referred to as a time shift function.

The network connection device and recorded program information can be grasped by a TV controller 140 and transmitted to the cloud service server 411 via the information processing apparatus. In this case, the time cloud service server 411 can grasp the user's home network connection device and recorded program information. Therefore, when each scene is reproduced on the basis of scene list information, the cloud service server 411 can specify even a home connection device in which the various scenes have been recorded.

A program signal demodulated in the DTV function block 14 or a program signal reproduced from a recording medium, such as a DVD, a BD, or an HD (hard disk), is subjected to various adjustments (including brightness adjustment and color adjustment) at a signal processing module 144 and is output to the screen 100 of the display module via an output module 145.

The DTV function block 14 includes a power circuit 146. The power circuit 146 can switch between a use situation of commercial power and a use situation of a battery 147 as needed. The switching between the use situations includes a case where the user performs the switching forcibly by operating the remote controller and a case where the switching is performed automatically on the basis of external information.

The cloud service server 411 can transmit a control signal to bring the TV apparatus into a 3D processing state automatically. Furthermore, the cloud service server 411 can transmit an audio control signal and/or an audio signal corresponding to a scene to the TV apparatus. Moreover, according to a scene, the cloud service server 411 can include image adjustment data in extended linkage data and transmit the resulting data.

The DTV function block 14 includes a short-distance wireless transceiver module 149. The DTV function block 14 can transmit and receive data to and from a mobile terminal via the short-distance wireless transceiver module 149. The mobile terminal can request an operation image from the DTV function block 14. When the DTV function block 14 has been requested to give an operation image, it can transmit a guide image as shown in FIGS. 3 and 4 to the mobile terminal. The user can control the information processing apparatus making use of the guide image on the mobile terminal.

The DTV function block 14 can check control data sent from the cloud service server 411 and reflect the data in an operation state automatically.

Therefore, with the system, the information processing apparatus basically transmits data (control signal corresponding to a scene information key, a scene list key, and a scene play key) acting as a trigger to a server via the network connection module in response to a first operation signal from the user. Next, the information processing apparatus acquires extended linkage data sent back on the basis of the trigger data, classifies a first control signal (instruction) for automatic control included in the extended linkage data and a second control signal (instruction) corresponding to the second operation signal from the user, and stores them. They are stored in the overall controller or model. Then, the information processing apparatus can perform an autonomic operation on the basis of the first control signal (instruction) and/or a heteronomous operation on the basis of the second control signal (instruction). The autonomic operation means operating in an autonomic manner. For example, this means obtaining a display image in the area 106 as shown in FIG. 4 and controlling the DTV function block 14. The heteronomous operation means waiting for a user operation and responding to a second operation signal when the second operation signal from the user is input. This operation includes the operation of responding to merchandise selection, the operation of responding to tag list selection, and the operation of responding to scene list selection as shown in FIGS. 6, 7, and 8. The extended linkage data further includes display data to be displayed. The display data includes various messages and albums. When having received a power-saving instruction from the time cloud service server 411, the DTV function block 14 can perform a power-saving operation. The power-saving operation includes, for example, the change of a full-segment reception state to a one-segment reception state, the reduction of the display area of the display module, and the change of commercial power use to battery use.

In addition, the DTV function block 14 can control the brightness of an area of a moving image in the area 101 so that the brightness may be higher than that of another area. That is, the DTV function block 14 can make the brightness of a guide image in the area 102-104 lower than that of a moving image in the area 101, thereby making the moving image easily viewable. To perform a specific operation, the DTV function block 14 can control the brightness of a guide image pointed to by the cursor so that the guide image may get brighter.

The method of controlling demonstration images, the method of controlling menu images, and the like in the apparatus are not limited to the embodiment explained in FIG. 1 to FIG. 4. Hereinafter, still other embodiments concerning the method of controlling demonstration images, the method of controlling menu images, and the like will be explained.

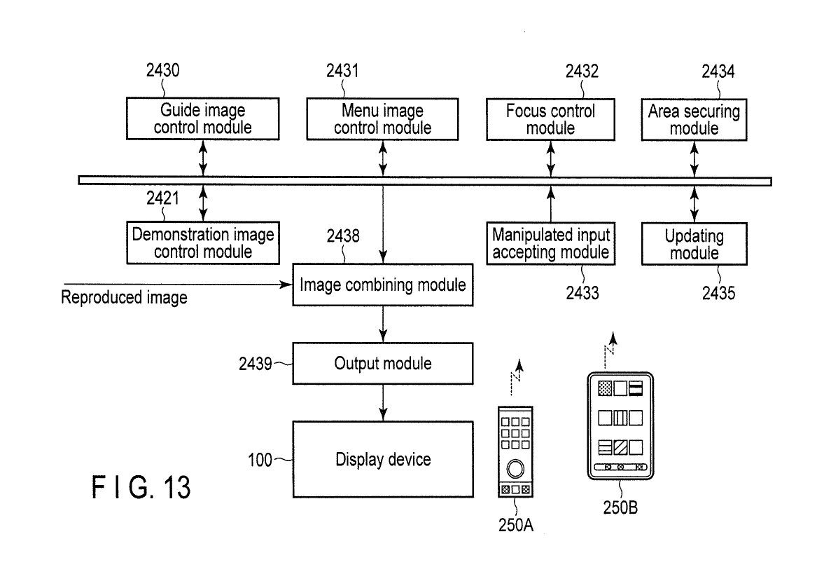

FIG. 13 selectively shows functional blocks related to image display. In these functional blocks, a demonstration image control module 2421, a guide image control module 2430, a menu image control module 2431, a focus control module 2432, a manipulated input accepting module 2433, an area securing module 2434, an image combining module 2438, an output module 2439, and the like are included in, for example, the information processing apparatus 222. These functional blocks may be configured in software or hardware or by combining software and hardware.

The demonstration image control module 2421 controls the display, change, or switching of the images explained in FIGS. 1 and 2 or demonstration images explained later. The guide image control module 2430 controls the display, change, or switching of guide images. The menu image control module 2431 controls the display, change, or switching of menu images explained later. The focus control module 2432 controls the movement of the cursor (also referred to as the focus) according to a manipulated input. A manipulated input based on the manipulation of the remote controller 250 or mobile terminal 250B is taken in from the manipulated input accepting module 2433. The area securing module 2434 can set an area where the focus moves on the screen. The focus movement will be explained in further detail later.

The image combining module 2438 combines a reproduced image (an image of a program reproduced from a recording medium or an image of an on-air program) with a guide image. The output module 3439 outputs the combined image to a display device. Hereinafter, an operation based on the above configuration will be explained.

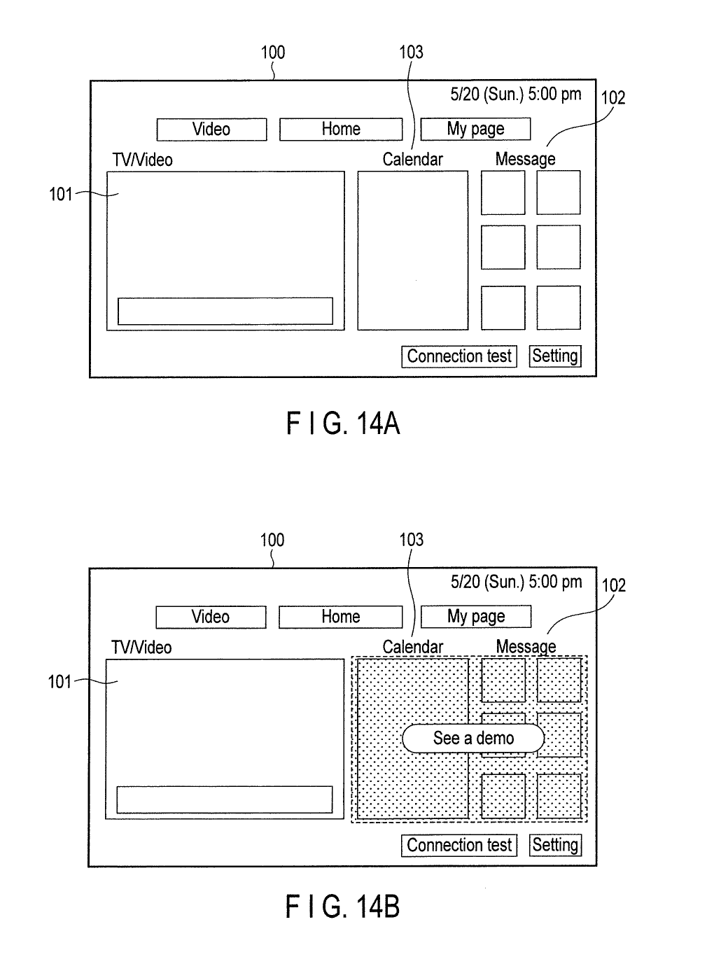

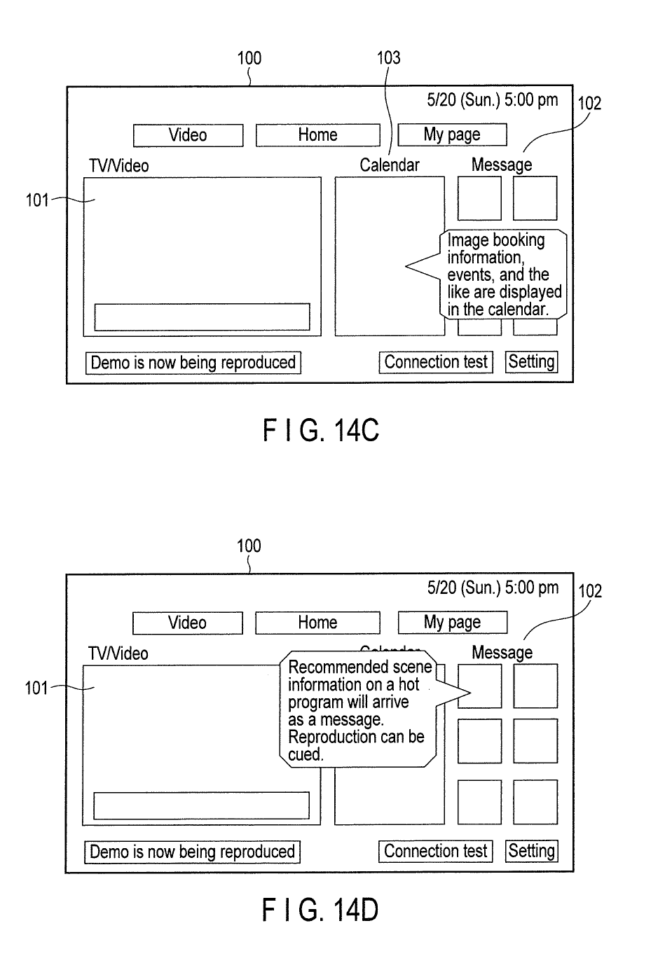

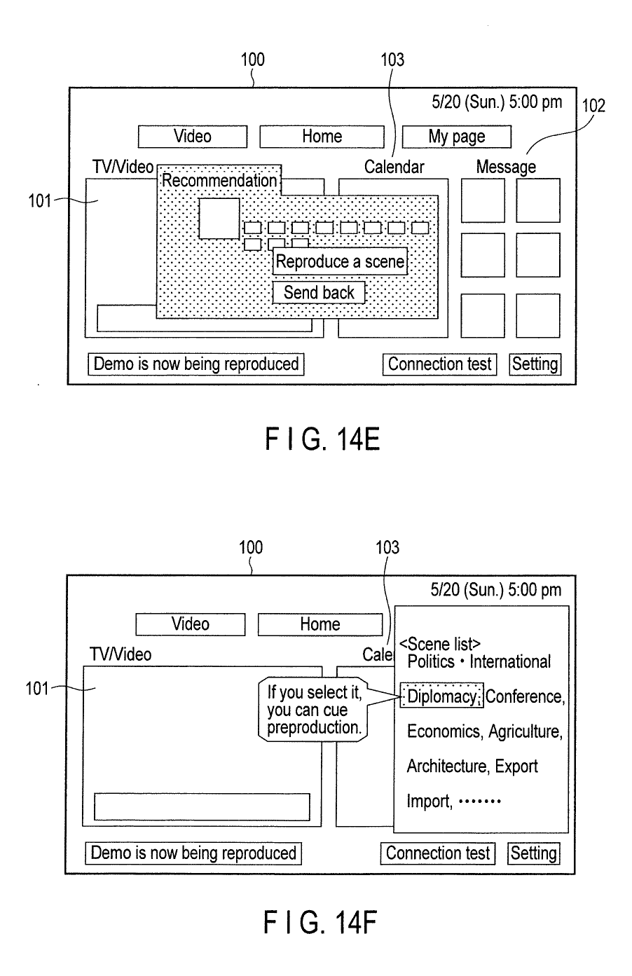

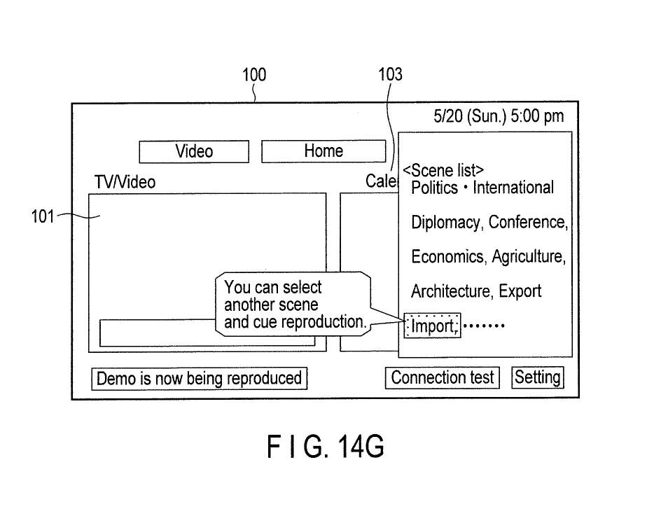

FIG. 14A to FIG. 14G are drawings to explain other examples of a demonstration image. The screen 100 of the display device of FIG. 14A shows an image when the power supply is turned on, with the TV apparatus not connected to the Internet. An image in the area 101 is an image of specific content. An image in each of the area 103 and area 102 is also an image of specific content. When the user has operated the remote controller to move the cursor, the cursor moves to, for example, a position as shown in FIG. 14B. That is, the positions of the areas 103, 102 are covered with the cursor.

At this time, the brightness of the areas 103, 102 is controlled so as to be lower and the remaining part becomes gray. In the center of the areas, for example, the message “See a demo” pops up. This enables the user to learn how to use the TV apparatus by demonstration. That is, the user can be introduced into a learning process of the function of the TV apparatus. With the message “See a demo” popping up, when the user operates the remote controller and presses the “Acknowledge” button, the image of FIG. 14B will transit to an image of FIG. 14B after a few seconds.

In an image of FIG. 14C, a message to explain how to use a calendar in the area 103 pops up. A main method of using the calendar will be explained in, for example, the message as follows: “Image booking information, events, and the like are displayed in the calendar.” In addition, after a few seconds, an image of FIG. 14D appears.

In an image of FIG. 14D, a message to explain how to use, for example, a message guide image in the area 102 pops up. A main method of using the message guide image will be explained in, for example, the message as follows: “Recommended scene information on a hot program will arrive at the message. Reproduction can be cued.” In addition, after a few seconds, an image of FIG. 14E appears.

In an image of FIG. 14E, for example, a sample of “Program recommended information” to which a typical thumbnail image has been attached is displayed. That is, the way of using a step following the message guide image is explained. In the image of “Recommended information on a program,” choices for determining whether to reproduce a scene, such as “reproduce a scene” or “send back,” appear. Seeing this, the user recognizes what processes the user will go through to acquire recommended information. Then, after a few seconds, an image of FIG. 14F appears.

In an image of FIG. 14F, a scene list is displayed as recommended information. The scene list is obtained by sampling a plurality of scenes in, for example, a certain program or certain content and organizing them into a list. One of the items has been focused on as if it were selected. Then, the guide “If you select it, you can cue preproduction” appears. Next, for example, the image of FIG. 14F transits to an image as shown in FIG. 14G, where one of another items has been focused on as if it were selected. Then, as a pop-up message, the guide “you can select another scene and cue reproduction” appears.

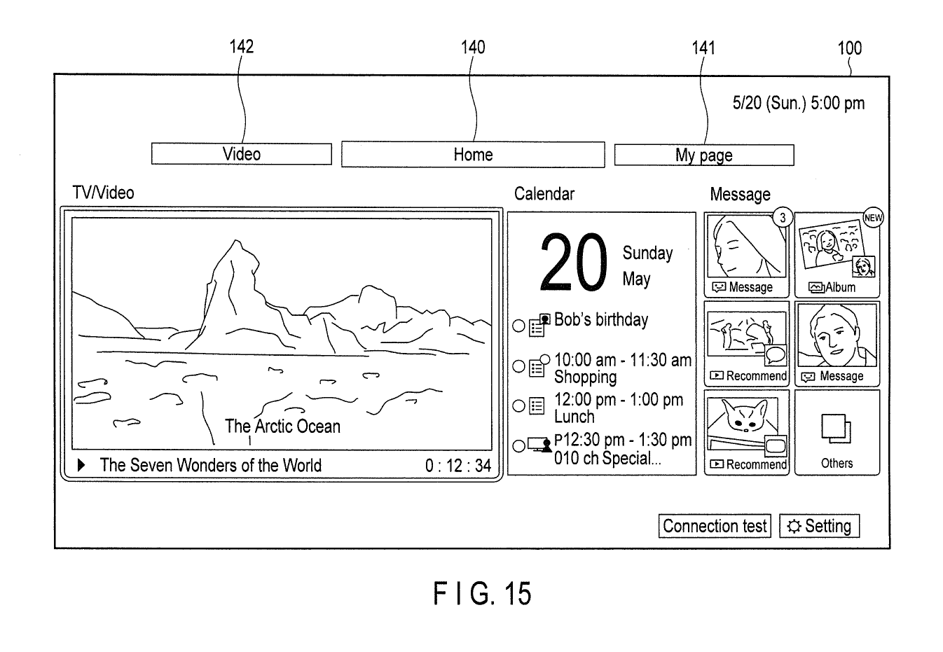

FIG. 15 shows that the states of the TV apparatus include “Home” 140, “My page” 141, and “Video” 142. These “Home” 140, “My page” 141, and “Video” 142 are shown in the form of tabs.

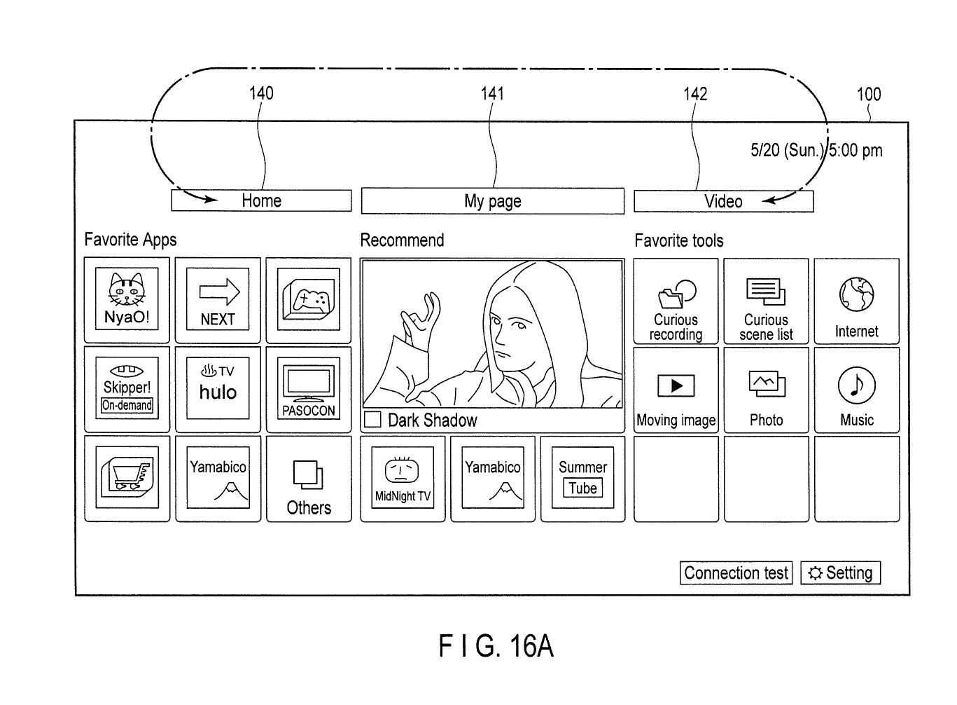

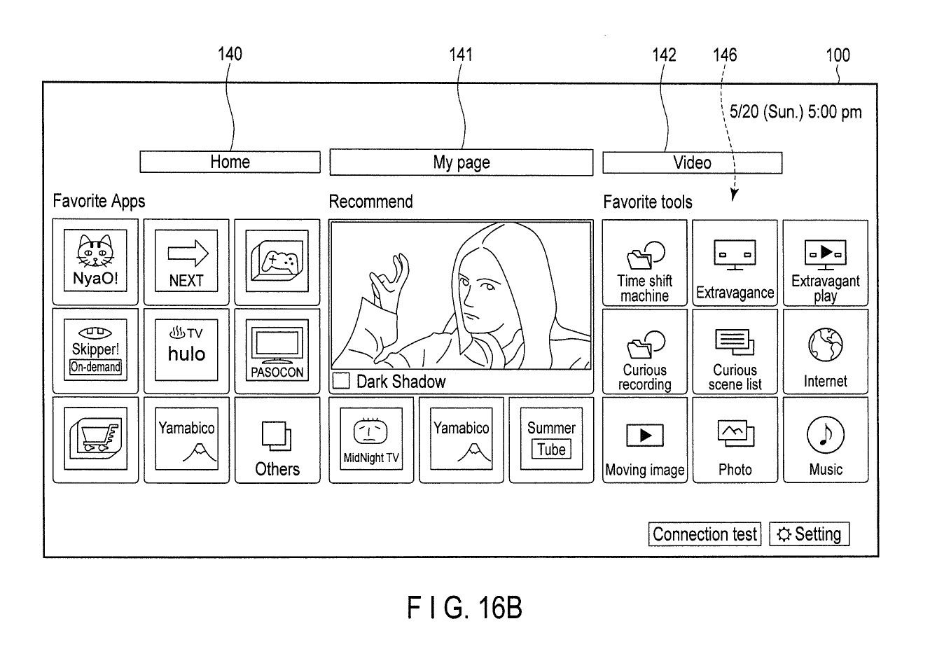

FIG. 15 has shown an image where “Home” 140 has been selected (highlighted in the center) as a state. However, the example of this state is not restrictive and a tab showing a “shopping” state may be further added. A desired tab can be selected with, for example, a left-pointing or right-pointing arrow cursor key. In the state of FIG. 15, when the right-pointing arrow has been operated, “My page” is selected and the tab of “My page” 141 moves to the center and is highlighted as shown in FIG. 16A. In the state of FIG. 16A, when the right-pointing arrow has been operated, the tab of “Video” 142 moves to the center and is highlighted.

As described above, of the tabs showing states, the one showing the current state is always positioned in the center and highlighted. Therefore, the user can understand the current state of the TV apparatus easily. Referring to the above image, the user can learn how to switch menu images. In addition, a pop-up menu appears, enabling the user to be introduced easily into the learning of menu images.

Furthermore, shown in the state of FIG. 16A are not only a plurality of guide images (samples) for connecting with various servers and guide images for favorite tools but also a guide image 145 representing “Others.” When the guide image 145 has been focused on and the “Acknowledge” button has been pressed, for example, a second-level menu image appears as shown in FIG. 16B. The menu image of FIG. 16B differs from that of FIG. 16A in that the number of guide images in the favorite tools of FIG. 16B increases. For example, guide images for “Time shift machine,” “Extravagance,” and “Extravagant play” appear.

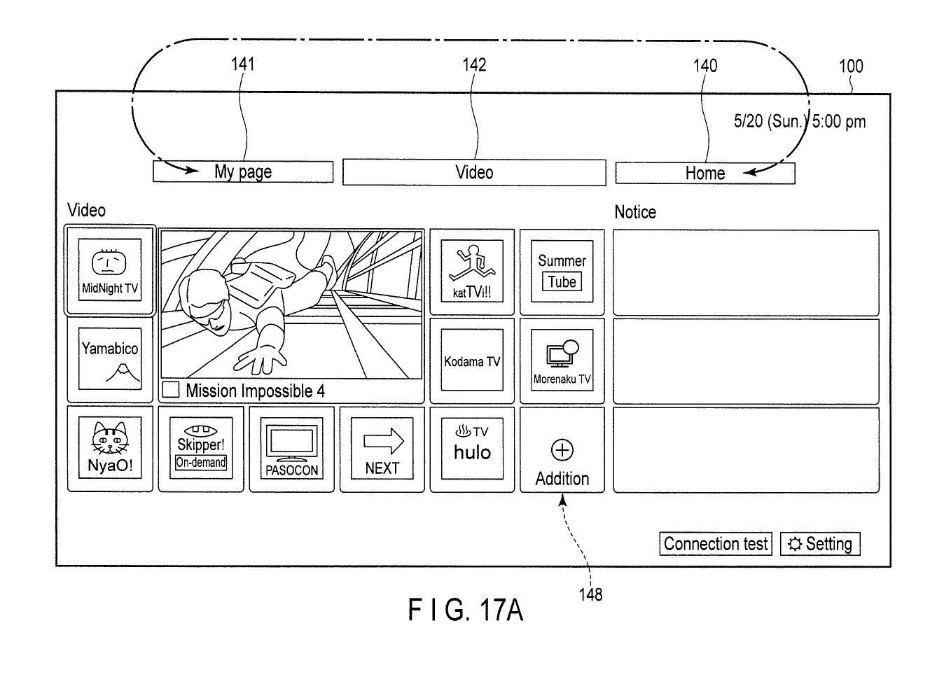

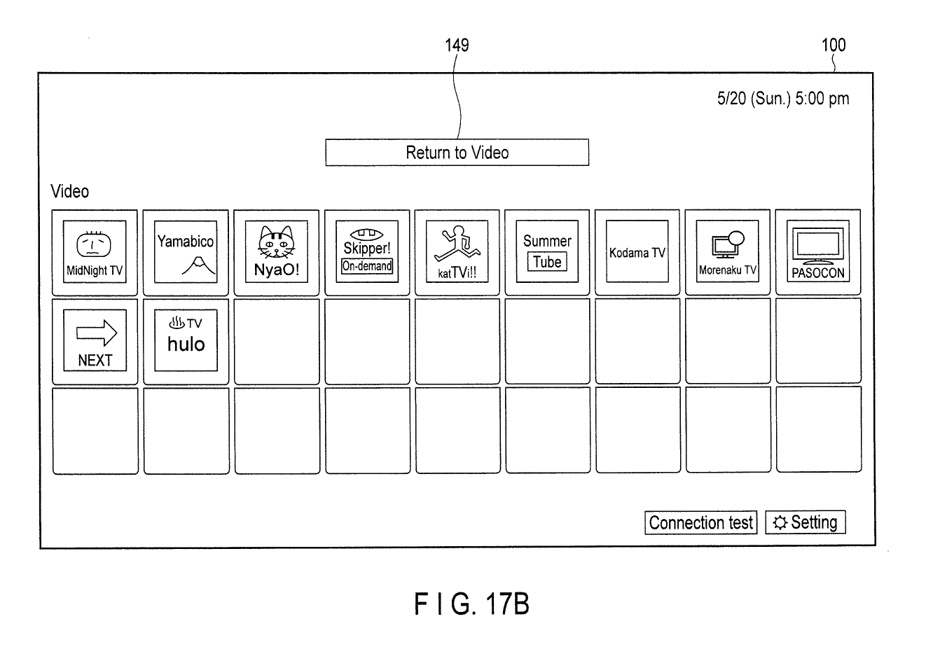

FIG. 17A shows an example of displaying a guide image about “Video.” In this menu image, a guide image 148 indicating “Addition” is displayed. When the guide image 148 has been focused on and the “Acknowledge” button has been pressed, for example, a second-level menu image as shown in FIG. 17B is displayed. In the second-level menu image, “Return to video” 149 appears as a tab.

After the aforementioned apparatus has been connected to the network, items (calendar area, message area) can be used as usual.

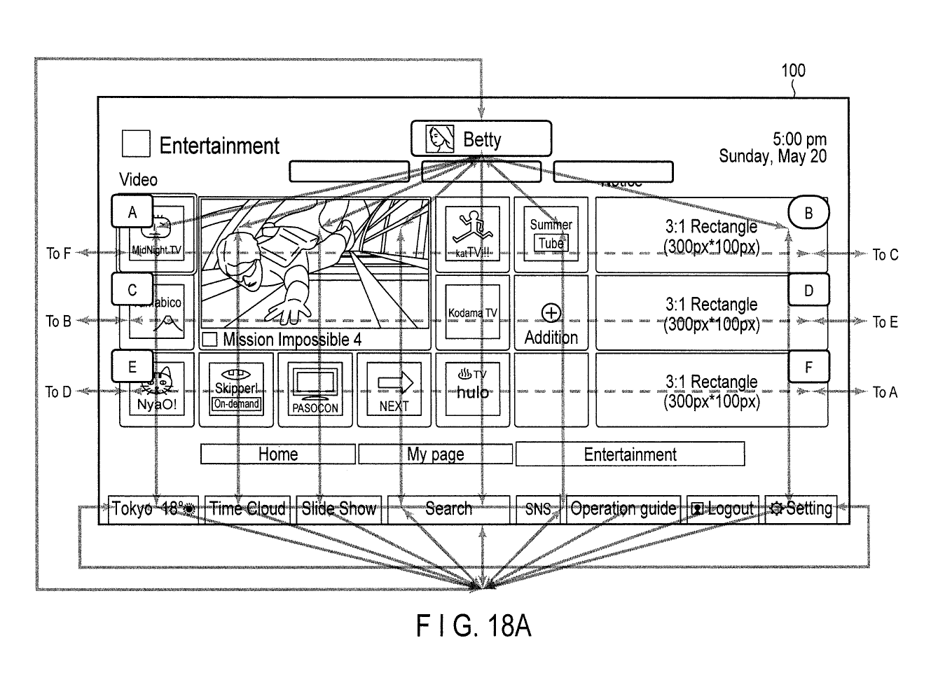

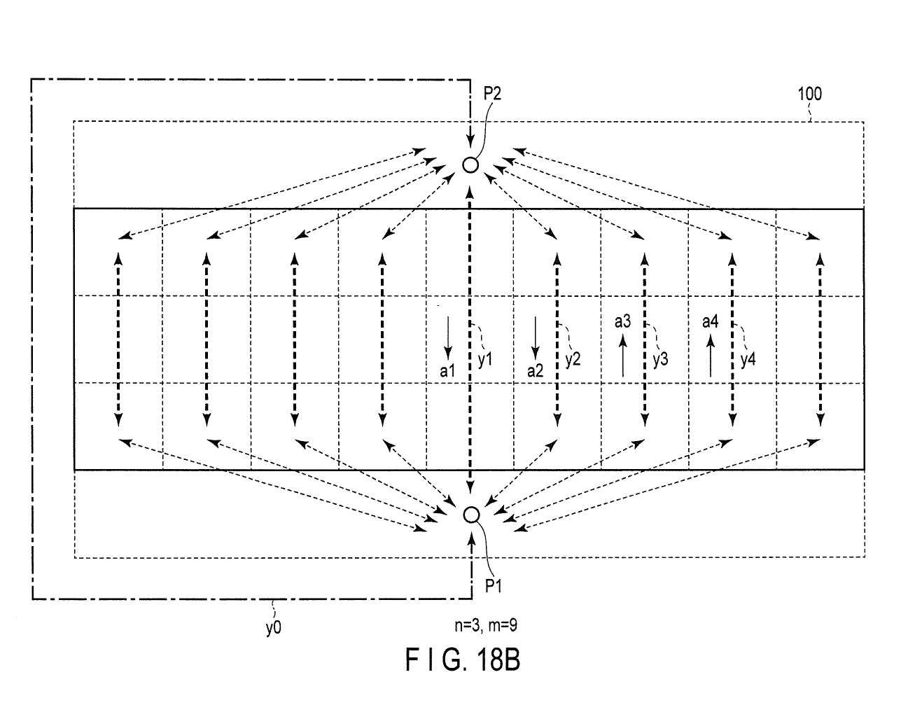

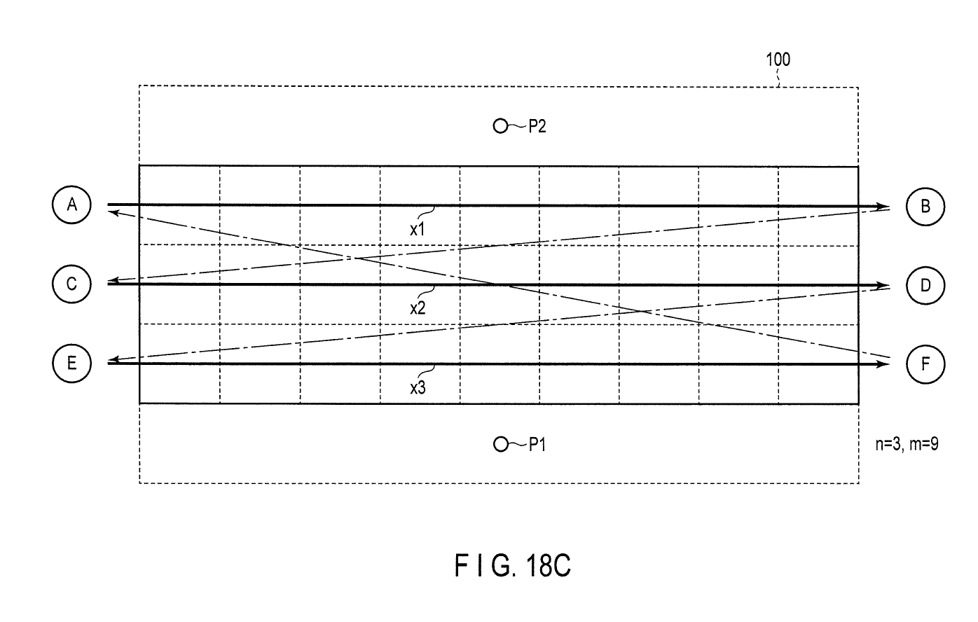

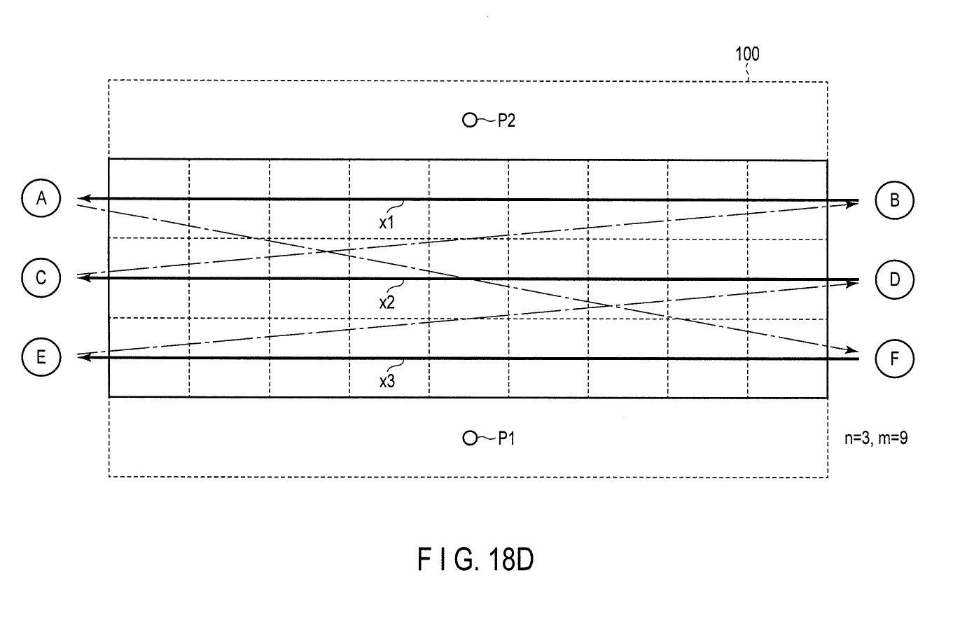

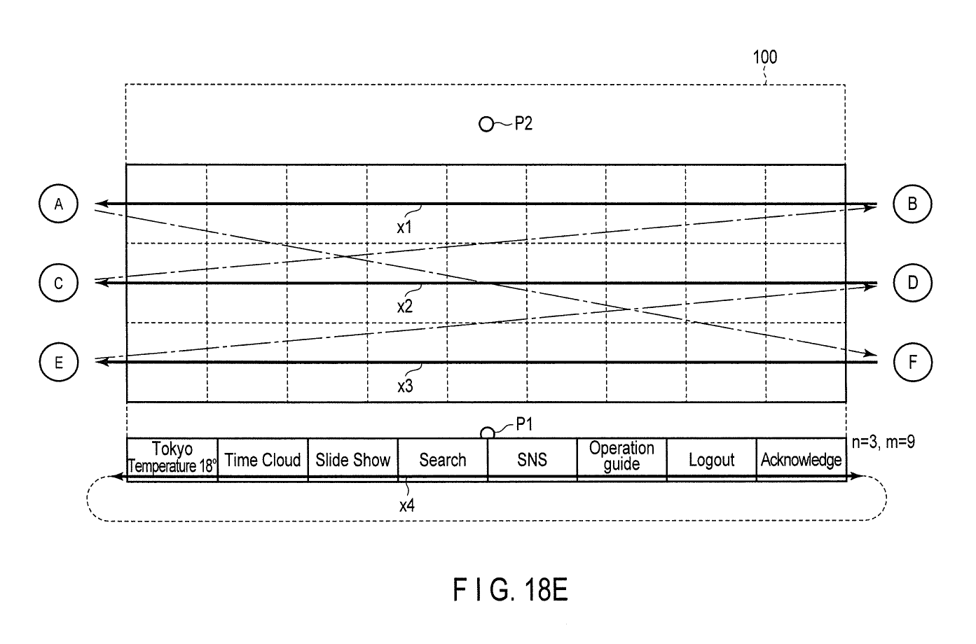

FIG. 18A shows an image when the TV apparatus has been connected to the Internet and logged into by, for example, “Betty.” The arrows shown in FIG. 18A show transfer pathways of the cursor (focus). Transfer pathways of the focus will be explained with reference to FIG. 18B and FIG. 18C. The transfer pathways of the focus are enabled on a demonstration image even if the TV apparatus is not in a login state.

On a screen of the embodiment, the display control module arranges and displays a plurality of buttons corresponding to one or more cells on a two-dimensional area which has (n×m) cells that has n rows in a Y direction and m columns in an X direction perpendicular to the Y direction. The focus control module moves the position of the focus to a button according to a manipulated input.

The control module includes a Y-direction control module that moves the focus to a button corresponding to at least an adjacent cell in the same column according to a manipulated input that moves the focus in the Y direction and an X-direction control module that moves the focus to a button corresponding to at least an adjacent cell in the same row or from a button corresponding to at least a cell at one end of a first row to a button corresponding to at least a cell at the other end of a second row adjacent to the first row according to a manipulated input that moves the focus in the X direction. The reason why the sentence “a button corresponding to at least a cell” has been written is that a cell may be represented as a single button or as a plurality of buttons. “One end of a row” corresponds to the left end when viewed from the right end of the row or the right end when viewed from the left end of the row. In addition, “the other end of a row” corresponds to the right end when viewed from the left end of the row or the left end when viewed from the right end of the row. The “an adjacent cell” is a cell on the right or left side of a reference cell or immediately above or below a reference cell.

On another screen of the embodiment, the screen 100 of the display device of the TV apparatus is divided into a plurality of cells and managed by the area securing module 2434 shown in FIG. 13. Specifically, the area securing module 2434 divides a two-dimensional area having an X (horizontal) direction and a Y direction (vertical) of the screen into an n number of pieces in the Y direction and an m number of pieces in the X direction, thereby securing a first area including (n×m) cells. Next, the area securing module 2434 secures a second area including (k1×k2) cells. The second area corresponds to a reproduced image (moving image) display area (101). The focus control module 2432 performs movement control of the focus in the two-dimensional area according to a manipulated input.

The movement of the cursor is controlled with, for example, the arrow keys (leftward, rightward, upward, and downward arrow keys) on the remote controller. When the arrow key is pressed continuously, the focus moves continuously. When the arrow key is pressed once, the focus moves by one cell.

The focus control module 2432 includes a Y-direction control module that moves the focus in an area of an n number of cells on a specific column in a specific direction repeatedly according to a manipulated input that moves the focus continuously in either direction of the Y direction. The focus control module 2432 further includes an X-direction control module that moves the focus in a cell area on a row on which the movement was started, transfers the focus to the head of the next row at the end of the current row, moves the focus in an area of an m number of cells on the next row, and transfers the focus to the head of the first row at the end of the last row. The focus control module 2432 further includes a jump control module that causes the focus to jump in a second area.

That is, FIG. 18B, FIG. 18C, and FIG. 18D show an example when n=3 and m=9. FIG. 18B shows a transfer pathway when the movement of the focus is controlled in the Y direction.

For example, when the remote controller has been operated so that the focus on any cell on pathway y1 may move continuously in a direction shown by arrow a1, the focus has a movement style as if it had returned, passing through point P1 and pathways y0, P2. In addition, when the remote controller has been operated so that the focus on any cell on pathway y2 may move continuously in a direction shown by arrow a2, the focus has a movement style as if it had returned, passing through point P1 and pathways y0, P2.

Furthermore, when the remote controller has been operated so that the focus on any cell on pathway y3 may move continuously in a direction shown by arrow a3, the focus has a movement style as if it had returned, passing through point P2 and pathways y0, P1. Moreover, when the remote controller has been operated so that the focus on any cell on pathway y4 may move continuously in a direction shown by arrow a4, the focus has a movement style as if it had returned, passing through point P2 and pathways y0, P1. When the operation of the remote controller has been stopped with the focus on any one of the cells, the focus comes to a stop on the cell.

FIG. 18C and FIG. 18D show transfer pathways when the movement of the focus is controlled in either direction of the X direction.

FIG. 18C shows a pathway when, for example, the rightward arrow on the remote controller has been operated to move the focus to the right continuously. For example, when the focus is on pathway x1, the focus moves in an A-B direction, jumps from the last cell to C, and transfers to the lift end of pathway x2. When the focus is on pathway x2, the focus moves in a C-D direction, jumps from the last cell to E, and transfers to the left end of pathway x3. When the focus is on pathway x3, the focus moves in a E-F direction, jumps from the last cell to A this time, and transfers to the left end of pathway x1. If the rightward arrow on the remote controller continues to be operated, the movement of the focus over the pathways is repeated.

FIG. 18D shows a pathway when, for example, the leftward arrow on the remote controller has been operated to move the focus to the left continuously. For example, when the focus is on pathway x3, the focus moves in an F-E direction, jumps from the last cell to D, and transfers to the right end of pathway x2. When the focus is on pathway x2, the focus moves in a D-C direction, jumps from the last cell to B, and transfers to the right end of pathway x3. When the focus is on pathway x3, the focus moves in a B-A direction, jumps from the last cell to F this time, and transfers to the right end of pathway x3. If the leftward arrow on the remote controller continues to be operated, the movement of the focus over the pathways is repeated.

As described above, the jump control module can move the focus in a cell area where the movement was started, transfer the focus to the head of the next row at the end of the current row, move the focus in an area of an m number of cells in the next row, and transfer the focus to the head of the first row at the end of the last row. However, the jump control module causes the focus to jump in a second area.

FIG. 18E shows the individual tabs (or buttons) for a plurality of “common tools” for menus. As “common menus,” for example, “Temperature information,” “Time cloud” for time cloud server login, “Slide show” for slide show instructions, “search” for searching, . . . , “Operation guide,” “Logout,” “Acknowledge,” and the like are arranged in a row. The focus can move over pathway x4 in the row. To introduce the focus into pathway x4, for example, the rightward or leftward arrow key is operated, and with the focus having moved to point P1, a desired tab can be selected.

The aforementioned focus control makes it easier to understand the movement rule of the focus. Therefore, even if many types of guide images exist on the screen 100, the selection of any guide image is made easier.

This apparatus is not limited to the above embodiment. For example, when a guide image is assumed to have been allocated to each of all the cells, if the number of guide images (also referred to as menus or buttons) is decreased by one, a double-wide guide image (menu) using two cells may appear. In contrast, when a guide image (menu) twice the size of a cell is present, if the number of guide images (menus) increases by one cell, what is obtained by reducing the double-wide guide image to half may appear.

With this apparatus, when a guide image (e.g., a guide image representing a calendar) is displayed on a tile of a plurality of cells (a set of cells), the focus indicates the guide image as a whole. In addition, the focus moves, jumping over the display part (the second area) for moving images like the area 101.

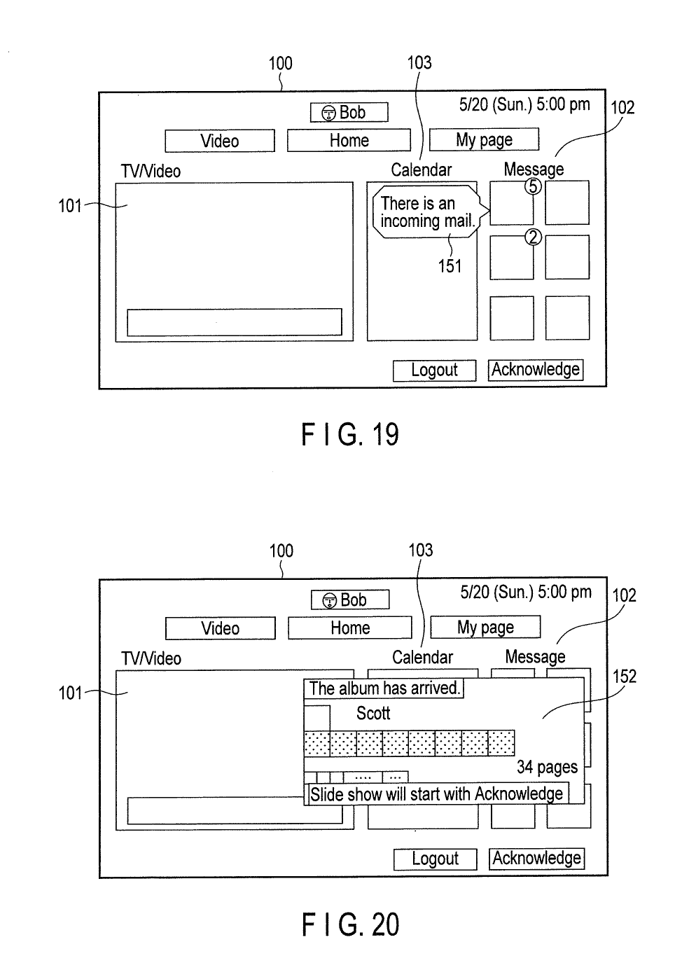

FIG. 19 shows an example of a pop-up image when a message has arrived from a family member or a close friend in the TV apparatus of the embodiment.

When a message has arrived, for example, a pop-up image saying “There is an incoming mail” 151 appears. The number of incoming massages is displayed at, for example, the right corner of a guide image (acting as an entrance) capable of entering an in-box for incoming messages. In FIG. 19, the number shows that there are five messages in the in-box.

FIG. 20 shows an example of a pop-up image when an album has arrived in the TV apparatus of the embodiment. In this case, an image 152 paired with “The album has arrived” pops up. The image 152 shows from whom the album has arrived (from Scott in this example) and how many photos are included (34 photos in this example). Here, a message that a slide show can be started when the “Acknowledge” button is pressed is displayed.

FIG. 21 shows an image when a message list has been displayed in the TV apparatus of the embodiment. When a message is opened, an in-box can be opened by selecting, for example, an appropriate guide image and pressing the “Acknowledge” button. In an image of a message list, a line in which a sender's name has been written is used as a thread. Following the thread, a message sentence is displayed. For example, on the left side of an image of the message list, a filter item is displayed. When a desired item has been focused on and the “Acknowledge” button has been pressed, a message corresponding to the selected item is displayed, with its priority being increased.

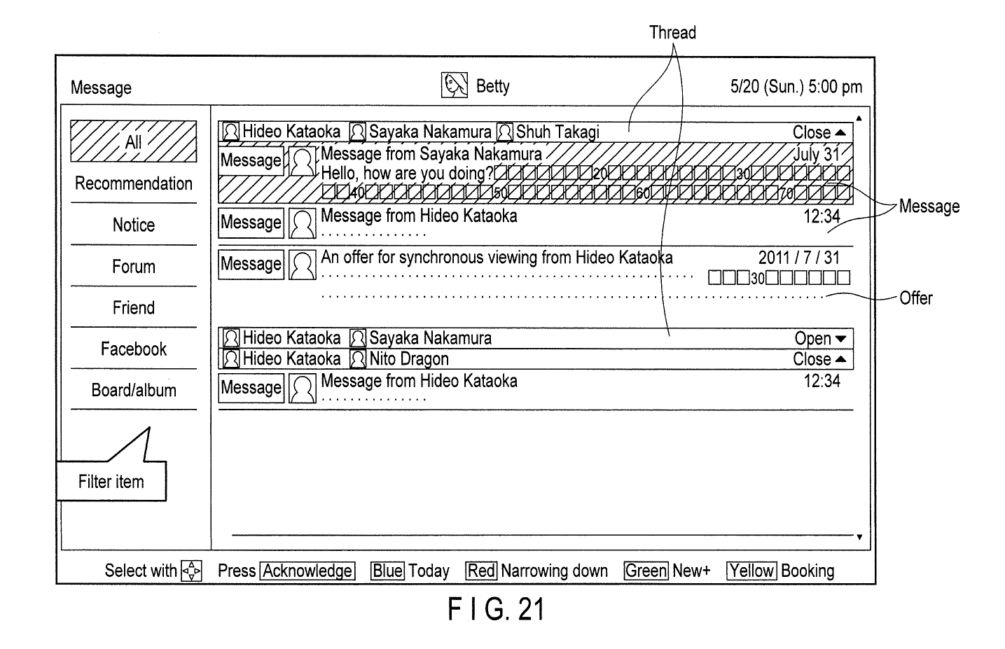

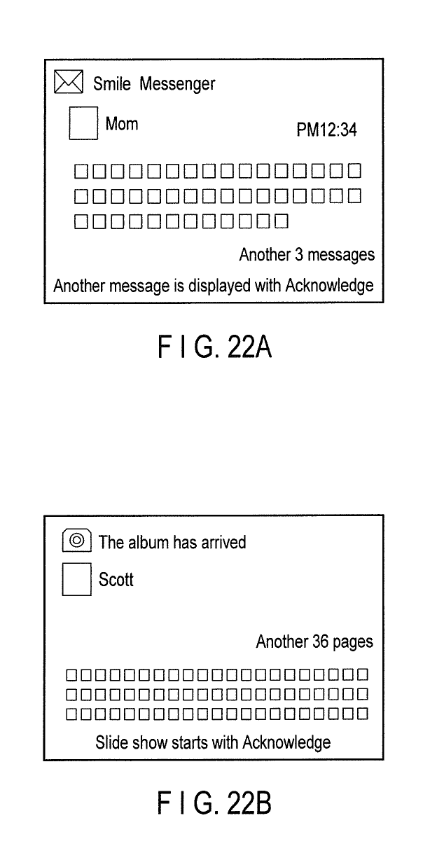

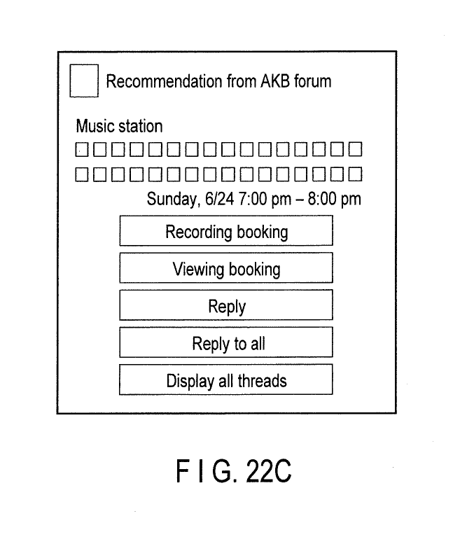

FIG. 22A shows an example of a pop-up image when a message from a smile messenger has arrived in the TV apparatus of the embodiment. This example shows a case where a message from a mother has arrived.

FIG. 22B shows another example of the pop-up image when an album has arrived in the TV apparatus of the embodiment.

FIG. 22C shows another example of the pop-up image when a message from a forum has arrived in the TV apparatus of the embodiment. When a message has arrived from the forum, selection buttons for content from the forum, including “Recording booking” and “Viewing booking,” are displayed. If “Recording booking” has been selected and “Acknowledge” has been pressed, when the content from the forum is delivered or broadcast, the content can be recorded in a recording device automatically.

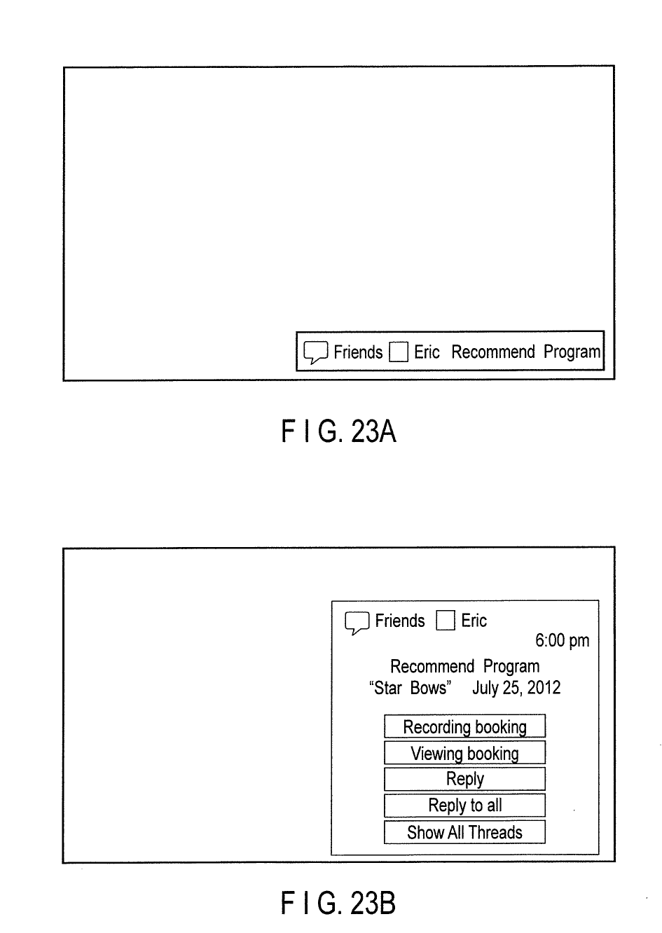

FIG. 23A shows an example of a pop-up image when a recommend message has arrived in the TV apparatus of the embodiment. If the recommend message is, for example, about a program, the user sometimes wants to view the recommended program. Then, if the user moves the cursor to the pop-up image of FIG. 23A, focuses on it, and presses the “Acknowledge” button, the user can obtain a guide image of FIG. 23B.

FIG. 23B shows an image appearing when a recommend message is opened from the image in FIG. 23A. In the image, selection buttons, including “Recording booking” and “Viewing booking,” are displayed. If “Recording booking” has been selected and the “Acknowledge” button has been pressed, when a recommended program is delivered or broadcast, content can be recorded in the recording device automatically. In addition, if “Viewing booking” has been selected and the “Acknowledge” button has been pressed, the current image is switched to an image for inputting time and date for viewing, enabling the time and date for viewing a recommended program to be set.

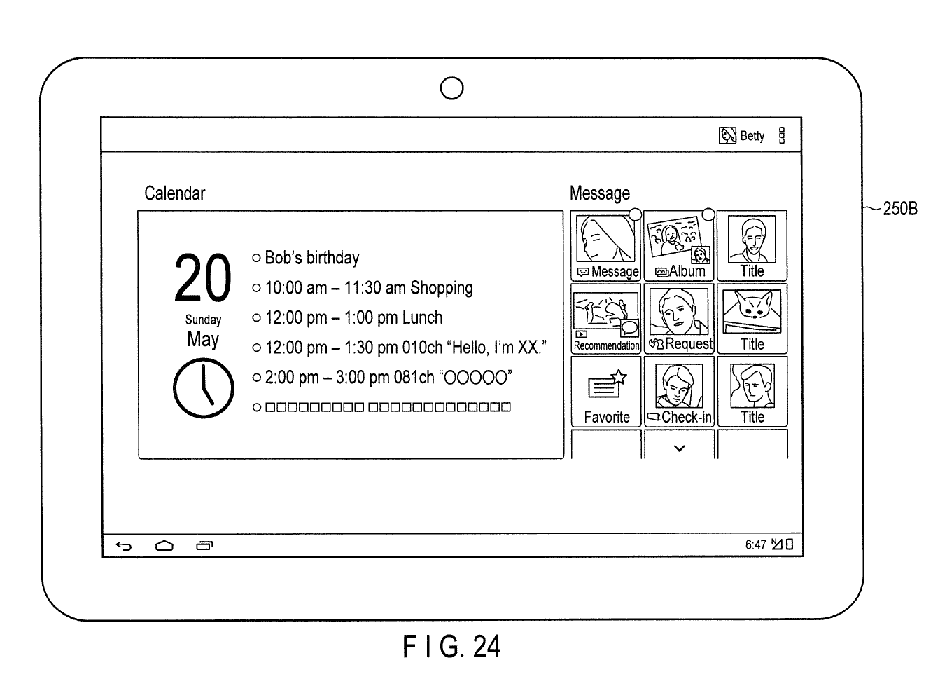

FIG. 24 shows a representation of guide images on a mobile terminal (tablet) that can communicate with the TV apparatus of the embodiment The TV apparatus, which can perform near field communication, can transmit image, data, and the like to a tablet 250B. The TV apparatus can also transmit addresses for various server connections. The TV apparatus can transmit a menu image at the request of the tablet 250B. However, the contents of moving images to be reproduced in the area 101 are removed from the menu images. Therefore, on the tablet 250B, menu images for messages and calendars are displayed.

The tablet 250B can communicate with the TV apparatus and acquire and display messages, calendar information, and the like that have arrived at the TV apparatus. In addition, the tablet 250B can log into an Internet server uniquely on the basis of a guide image.

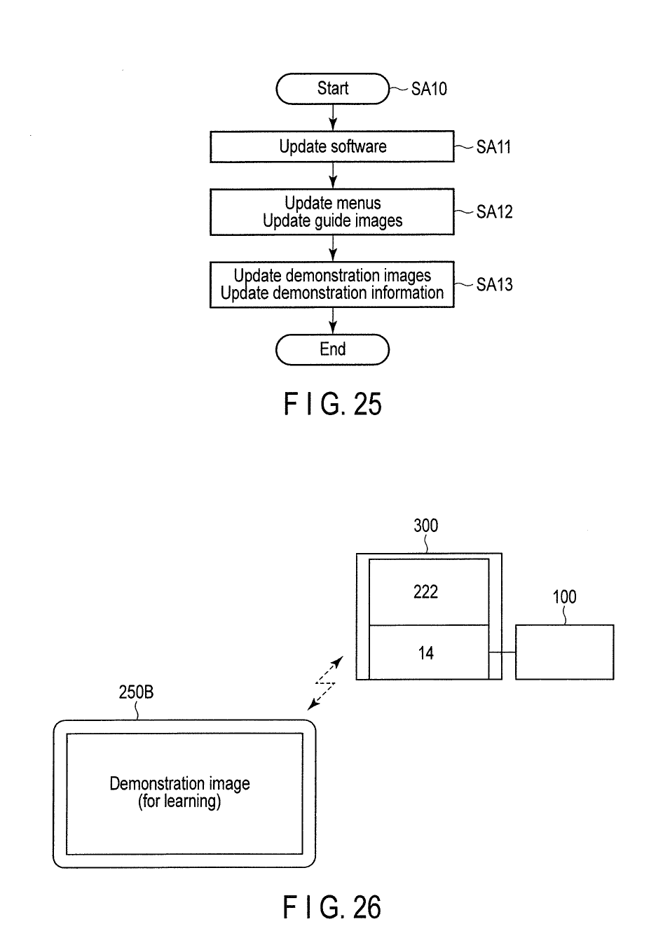

FIG. 25 is a flowchart to explain an operation when software has been updated in the TV apparatus of the embodiment. Software may be updated or new software may be added. In that case, a new function can start on the TV apparatus. Therefore, when software has been updated (step SA11), the TV apparatus can update the menu images and guide images accordingly (step SA12). Furthermore, the TV apparatus updates demonstration images and demonstration information so that the user can understand new functions (step SA13). These update processes are performed by an updating module 2435 shown in FIG. 13.

FIG. 26 is a diagram to explain the relationship between the TV apparatus of the embodiment and the mobile terminal (tablet). With the apparatus of the embodiment, when new software or upgraded software has been taken into from an external server, a message pops up for a given length of time in the case of, for example, the “Home” screen or “My page” screen.

When a new image or information processing function has been added, changed, or partially deleted, the user has to learn a new function or other aspect. Therefore, with this apparatus, a demonstration image is transferred to the tablet 250B, enabling the user to learn, viewing the tablet 250B. This enables the user to learn the new function without displaying the demonstration image on the TV apparatus.

FIG. 13 shows a block configuration. However, in the systems in FIG. 5 and FIG. 12, the blocks of FIG. 13 can be configured using software (a program) that realizes the operation of the block configuration. Furthermore, a storage medium (e.g., a semiconductor memory, a magnetic disk, or an optical disk) that stores the software (program) is also in the scope of the invention. The way the user gives operational instructions is not limited to the methods described in the specification. Various suitable realization methods may be used.

In the above explanation, even when a claim is expressed by dividing a structural element of the claim into subelements, by putting some of the subelements together, or by combining the subelements, it is still in the scope of the invention. Furthermore, even when a claim is expressed as a method, the method is equivalent to the application of an apparatus of the invention. Moreover, the name of each part is not restrictive. Naturally, it may be replaced with a module, a block, a unit, a circuit, means, a part, a device, logic, or the like.

While certain embodiments of the invention have been described, these embodiments have been presented by way of example only, and are not intended to limit the scope of the invention. Various omissions, substitutions, and changes in the form of the embodiments may be made without departing from the spirit of the invention. These embodiments and modifications are included not only in the scope and spirit of the invention but also in the invention written in the scope of the claims and its equivalence.

The technical terms used above in relation to the embodiments and the names or technical terms described in the drawings are in no way restrictive. For example, the processor may be replaced with processing means, a processing unit, or a processing module. Likewise, the controller may be replaced with a control means, a control unit, or a control module. The managing unit may be replaced with a manager, managing means, or a managing module. The generator may be replaced with generating means, a generating unit, or a generating module. The storage unit may be replaced with storage means, a storage, or a storage module. The collection and correction unit may be replaced with collection and correction means, or a collection and correction device. The registration unit may be replaced with registration means, a registration device, or a registration module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display controller configured to display, on a screen, a plurality of buttons corresponding to one or more cells on a two-dimensional area, the two-dimensional area including (n×m) cells that include an n number of rows in a Y direction and an m number of columns in an X direction perpendicular to the Y direction; and
a controller configured to move a focus of a button according to a manipulation and which includes
a Y-direction controller configured to move a focus to a button corresponding to at least an adjacent cell in a same column according to a manipulation that moves a focus in the Y direction, and
an X-direction controller configured to move a focus to a button corresponding to at least an adjacent cell in a same row or from a button corresponding to at least a cell at one end of a first row to a button corresponding to at least a cell at an other end of a second row adjacent to the first row according to a manipulation that moves a focus in the X direction.

2. The information processing apparatus of claim 1, wherein the Y direction is in a longitudinal direction of the screen and the X-direction is in a lateral direction of the screen.

3. The information processing apparatus of claim 1, wherein the n is three and the m is nine.

4. The information processing apparatus of claim 1, wherein the X-direction controller moves a focus in the X direction in a state where a focus is at a stop at any one of the n number of cells under the control of the Y-direction controller.

5. The information processing apparatus of claim 1, wherein a focus indicates the whole of a guide image when a guide image is displayed on a tile including a plurality of cells.

6. The information processing apparatus of claim 1, wherein a guide image displayed on a tile including a plurality of cells is an image of a calendar.

7. The information processing apparatus of claim 1, wherein the guide image displayed on the cells is a guide image for opening an in-box for an incoming message.

8. The information processing apparatus of claim 1, wherein the guide image displayed on the cells is a guide image which is for opening an in-box for an incoming message and on a part of which a number representing the number of incoming messages is displayed.

9. The information processing apparatus of claim 1, further comprising a plurality of tabs representing the types of menu images which are displayed so as to be arranged in a horizontal direction of the screen,
wherein a tab of a menu image selected and acknowledged is displayed in the center so as to be highlighted.

10. The information processing apparatus of claim 9, wherein the tabs includes “Home,” “My page,” and “Video.”

11. An information processing method which uses an area securing module that secures a two-dimensional area for display on a screen of a display and a controller that performs movement control of a focus that selectively indicates a part of the two-dimensional area, the two-dimensional area for display including (n×m) cells that include an n number of rows in a Y direction and an m number of columns in an X direction perpendicular to the Y direction, the information processing method comprising:
displaying a plurality of buttons corresponding to one or more cells;
moving a focus of a button according to a manipulation;
moving a focus to a button corresponding to at least an adjacent cell in the same column according to a manipulation that moves a focus in the Y direction; and
moving a focus to a button corresponding to at least an adjacent cell in the same row or from a button corresponding to at least a cell at one end of a first row to a button corresponding to at least a cell at the other end of a second row adjacent to the first row according to a manipulation that moves a focus in the X direction.

12. The information processing method of claim 11, wherein the Y direction is in a longitudinal direction of the screen and the X-direction is in a lateral direction of the screen.

13. The information processing method of claim 11, wherein the n is three and the m is nine.

14. The information processing method of claim 11, wherein the moving a focus in the X direction is in a state where a focus is at a stop at any one of the n number of cells under the control of the Y-direction controller.

15. The information processing method of claim 11, wherein a focus indicates the whole of a guide image when a guide image is displayed on a tile including a plurality of cells.

16. The information processing method of claim 11, wherein a guide image displayed on a tile including a plurality of cells is an image of a calendar.

17. The information processing method of claim 11, wherein the guide image displayed on the cells is a guide image for opening an in-box for an incoming message.

18. The information processing method of claim 11, wherein the guide image displayed on the cells is a guide image which is for opening an in-box for an incoming message and on a part of which a number representing the number of incoming messages is displayed.

19. The information processing method of claim 11, further comprising a plurality of tabs representing the types of menu images which are displayed so as to be arranged in a horizontal direction of the screen,
wherein a tab of a menu image selected and acknowledged is displayed in the center so as to be highlighted.

20. The information processing method of claim 19, wherein the tabs includes “Home,” “My page,” and “Video.”

21. An information recording medium which stores a program for operating an area securing module that secures a two-dimensional area for display on a screen of a display and a controller that performs movement control of a focus that selectively indicates a part of the two-dimensional area, the two-dimensional area for display including (n×m) cells that include an n number of rows in a Y direction and an m number of columns in an X direction perpendicular to the Y direction,
wherein the program includes
a command to display a plurality of buttons corresponding to one or more cells;
a command to move a focus of a button according to a manipulation;
a command to move a focus to a button corresponding to at least an adjacent cell in the same column according to a manipulation that moves a focus in the Y direction; and
a command to move a focus to a button corresponding to at least an adjacent cell in the same row or from a button corresponding to at least a cell at one end of a first row to a button corresponding to at least a cell at the other end of a second row adjacent to the first row according to a manipulation that moves a focus in the X direction.

22. The information processing medium of claim 21, wherein the Y direction is in a longitudinal direction of the screen and the X-direction is in a lateral direction of the screen.

23. The information processing medium of claim 21, wherein the n is three and the m is nine.

24. The information processing medium of claim 21, wherein a command moves a focus in the X direction in a state where a focus is at a stop at any one of the n number of cells under the control of the controller.

25. The information processing medium of claim 21, wherein a focus indicates the whole of a guide image when a guide image is displayed on a tile including a plurality of cells.

26. The information processing medium of claim 21, wherein a guide image displayed on a tile including a plurality of cells is an image of a calendar.

27. The information processing medium of claim 21, wherein the guide image displayed on the cells is a guide image for opening an in-box for an incoming message.

28. The information processing medium of claim 21, wherein the guide image displayed on the cells is a guide image which is for opening an in-box for an incoming message and on a part of which a number representing the number of incoming messages is displayed.

29. The information processing medium of claim 21, further comprising a plurality of tabs representing the types of menu images which are displayed so as to be arranged in a horizontal direction of the screen,
wherein a tab of a menu image selected and acknowledged is displayed in the center so as to be highlighted.

30. The information processing medium of claim 29, wherein the tabs includes “Home,” “My page,” and “Video.”
